(19) United States
(12) Patent Application Publication
(10) Pub. No.: US 2017/0124793 A1
(43) Pub. Date: May 4, 2017

(54) VOTING SYSTEMS AND METHODS

(71) Applicant: SHOWT INNOVATIONS LIMITED, Floriana (MT)

(72) Inventors: Kanav SUD, Pondicherry (IN); Michael Richard MARCH, Nonthaburi (TH); Andrew Steven JACOBS, Chevy Chase, MD (US)

(73) Assignee: SHOWT INNOVATIONS LIMITED, Floriana (MT)

(21) Appl. No.: 15/336,975

(22) Filed: Oct. 28, 2016

Related U.S. Application Data
(60) Provisional application No. 62/249,081, filed on Oct. 30, 2015.

(51) Int. Cl. G07C 13/00

(52) U.S. Cl. CPC G07C 13/00; G06Q 2230/00

(57) ABSTRACT

Voting systems and methods may include a server comprising a processor and a memory. The processor may receive voting data and analyze the voting data to identify a topic from among a plurality of topics and a vote associated with the identified topic. The processor may tally the vote for the identified topic.

### CROSS-REFERENCE TO RELATED APPLICATION

This application claims priority from U.S. Provisional Application No. 62/249,081, entitled “Voting Systems and Methods,” filed Oct. 30, 2015, the entirety of which is incorporated by reference herein.

### BRIEF DESCRIPTIONS OF THE DRAWINGS

FIG. 1A is a network according to an embodiment of the invention.

FIGS. 1B-1E show a network according to an embodiment of the invention.

FIG. 2 is a vote server and vote database according to an embodiment of the invention.

FIG. 3 is a parser server and parser database according to an embodiment of the invention.

FIG. 4 is a server network according to an embodiment of the invention.

FIGS. 5-29 are screenshots of an interactive voting user interface (UI) according to an embodiment of the invention.

FIG. 30 is a UI launch process according to an embodiment of the invention.

FIG. 31 is a search process according to an embodiment of the invention.

FIG. 32 is a headline display process according to an embodiment of the invention.

FIG. 33 is a trending topic display process according to an embodiment of the invention.

FIG. 34 is an activity display process according to an embodiment of the invention.

FIG. 35 is a followed topic display process according to an embodiment of the invention.

FIG. 36 is a settings adjustment process according to an embodiment of the invention.

FIG. 37 is a help display process according to an embodiment of the invention.

FIG. 38 is a feedback entry process according to an embodiment of the invention.

FIG. 39 is a vote entry process according to an embodiment of the invention.

FIG. 40 is a free-form voting process according to an embodiment of the invention.

FIGS. 41A-41B show a free-form voting process according to an embodiment of the invention.

FIGS. 42-43 are screenshots of a free-form voting UI according to an embodiment of the invention.

FIG. 44 is a screenshot of a website with embedded news widget according to an embodiment of the invention.

### DETAILED DESCRIPTIONS OF SEVERAL EMBODIMENTS

Systems and methods described herein may collect and analyze voting data from a variety of sources which may obtain the voting data in disparate formats. Using mobile telecommunication devices, interne-enabled computers and tablets, and/or other devices, users may be able to send information indicative of an opinion about one or more topics to a central location such as one or more servers. The received information may be transformed into a yes or no vote on the topic, regardless of its initial format, for example. These votes may be collected and used for a variety of purposes, such as aggregation, research, polling, etc. In some cases, subjects of voting, such as celebrities or businesses, may be able to respond to the voting. This may include delivering messages to each voter that may be customized based on whether the voter sent a yes or a no vote. Note that while the embodiments described in detail herein register yes and no votes, some embodiments of the systems and methods described herein may offer other voting choices (e.g., a preference among a variety of options).

Some embodiments may provide an anonymous or mostly anonymous platform for the public all over the world to quickly and easily vote yes or no for any public figure and immediately receive a message containing the global aggregated tally of that voting, along with a message from the public figure written especially for the platform customized to whether the voter has voted yes or no, and an advertisement tailored to the vote. The public may use the platform to not just vote about public figures, but also products, films, television programs, songs, issues, sports teams, companies, organizations, places, and service workers, etc., and in any of these cases the vote recipient or their representative may have the ability to create a return message to the voter.

In some embodiments, a profile may be maintained about how each individual votes, which may be updated every time a vote is transmitted. This profile data may be shared with advertisers to help them choose advertisements to send to that individual's device.

In some embodiments, real-time aggregated voting data may be provided to a mobile or computer device. As votes are submitted about the public figure the display of the device may be changed.

In some embodiments, the tally of the vote for various topics may be stored in a database. The vote tally may be identified in many different ways. The tally may be identified by location, current message data, input, and the like.

Any event, entity or concept may be entered into the system to be voted upon. They may be managed and/or curated. They may be conducted with an audience that is local or national in scope. In addition to supporting such voting, systems and methods described herein may also be used to create an enormous database of issues, people, products, places, sports teams, organizations, companies, songs, albums, TV shows, films, etc., such that virtually the entire universe of topics may be present and available to be voted on. The database may be updated as new topics emerge. Because of the comprehensive nature of this database, individuals anywhere in the world may not have to wait to be asked about something to voice an opinion on it; they may seize the initiative at any time to express their opinion about virtually anyone and anything. Such a voting system may be available at all times globally. To aid in this effort, items (both possible votes (e.g., yes or no) and topics) may be translated into a variety of languages (e.g., 62 major languages). Therefore, the systems and methods described herein may support voting wherein the entire world can express themselves on any issue at any time in any language, when they want to, not when someone asks them. Given the vast amounts of data involved with receiving, analyzing, tallying, and reporting votes from numerous, geographically diverse users on multiple topics at all times, the systems and methods described herein may be specifically configured for management of constantly changing data states at very large scales.

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. Those of ordinary skill in the art will appreciate that those terms used herein are interchangeable, and any computer capable of performing the described functions may be used. For example, though the term “smartphone” may appear in the specification, the disclosed embodiments are not limited to smartphones. In some embodiments, the computers used in the described systems and methods may be special purpose computers configured specifically for vote processing. For example, a server may be equipped with specialized processors, memory, communication components, etc. that are configured to work together to perform functions such as receiving voting data, analyzing the voting data to identify a topic from among a plurality of topics and a vote associated with the identified topic, tallying the vote for the identified topic, etc.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, or other wireless connection). Connections between computers may use any protocols, including connection-oriented protocols such as TCP or connectionless protocols such as UDP. Any connection through which at least two computers may exchange data can be the basis of a network.

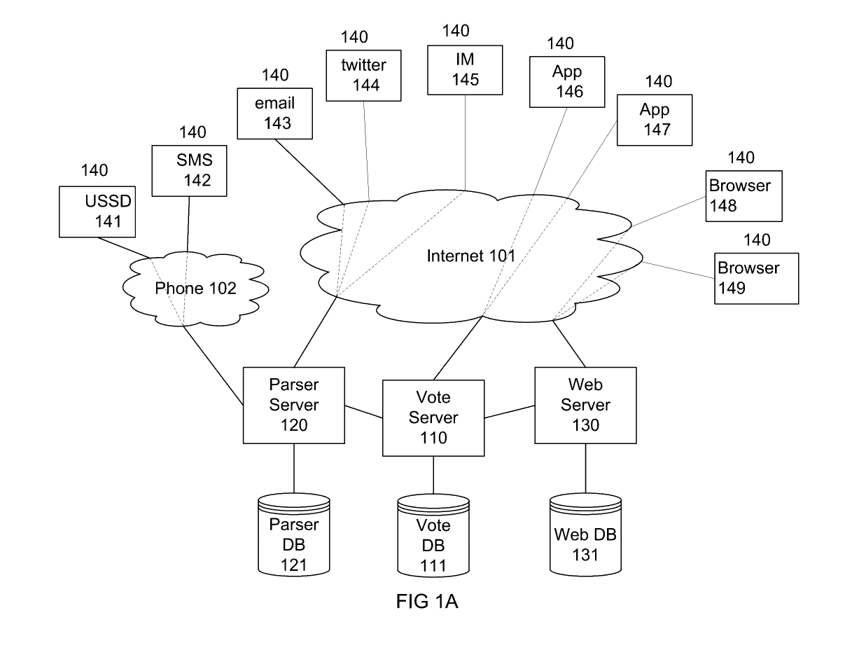

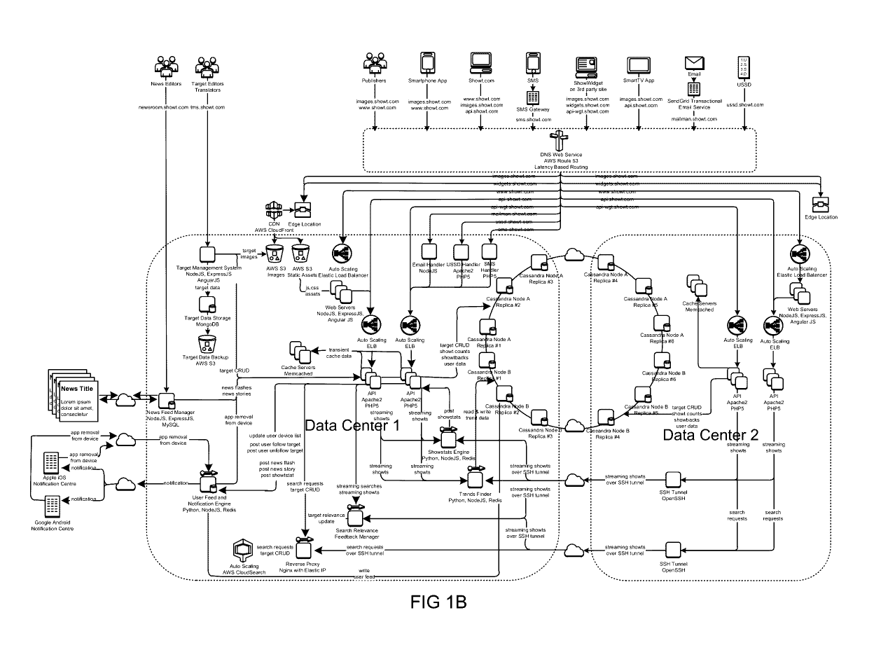

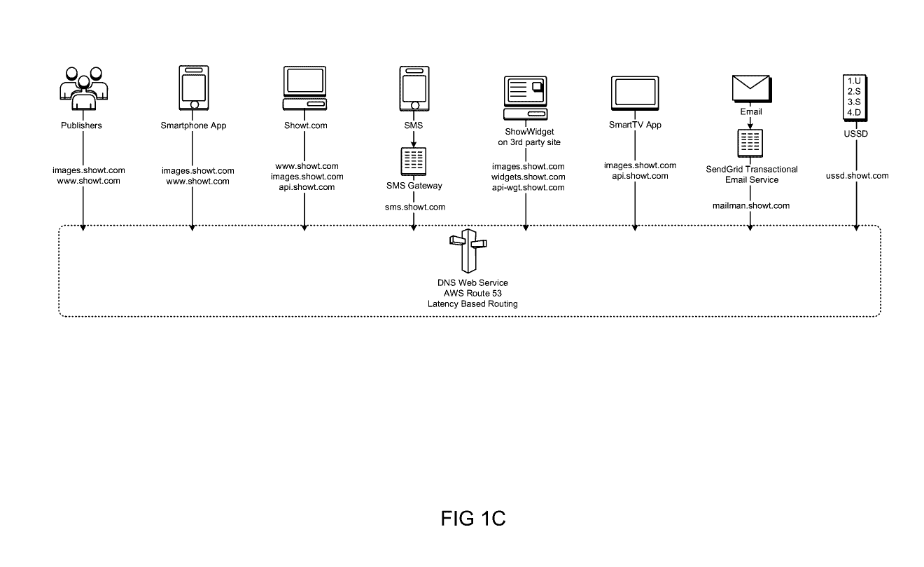

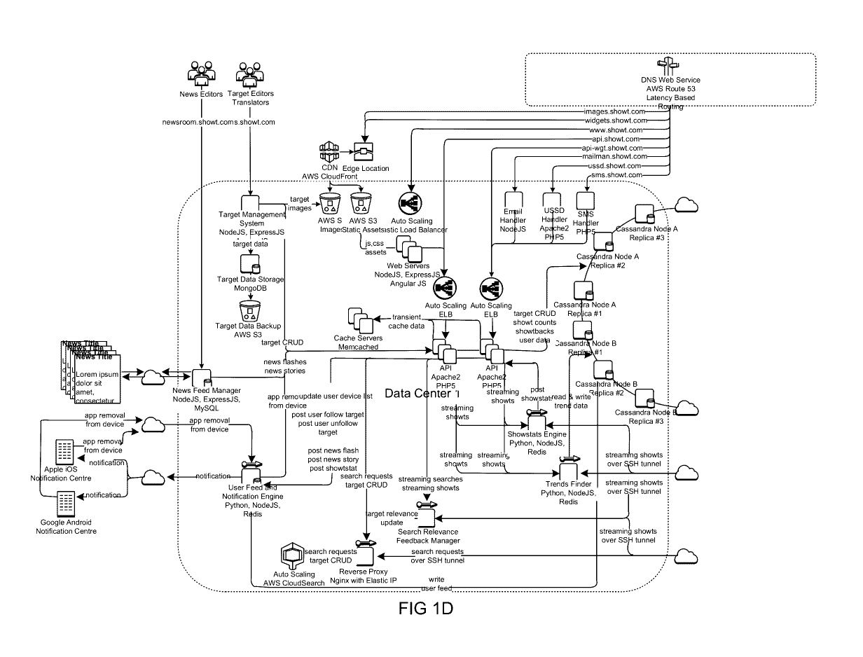

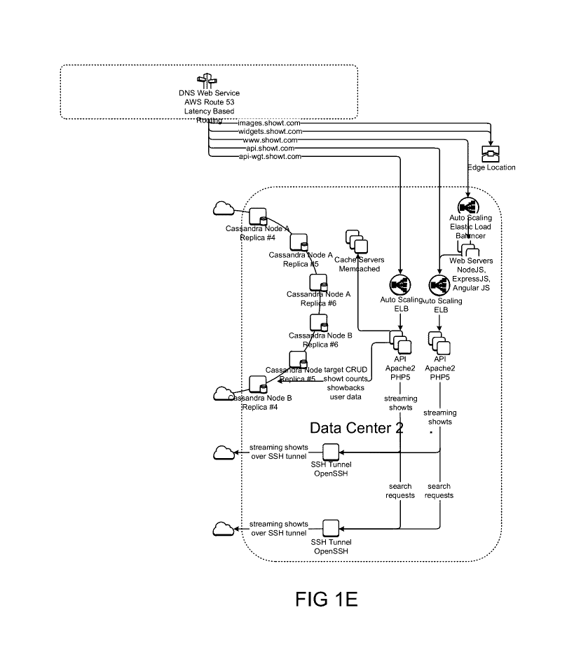

FIG. 1A is a network 100 according to an embodiment of the invention. The example network 100 includes a variety of voting devices 140 which may communicate data via the Internet 101 or other computer networks and/or via phone (e.g., cellular) networks 102. Devices 140 may communicate via Unstructured Supplementary Service Data (USSD) 141, Short Message Service (SMS)/Multimedia Messaging Service (MMS) 142, email 143, Twitter 144, instant message (IM) 145, dedicated voting applications configured for various device 140 operating systems and/or configurations 146/147 (wherein 146 and 147 may be different applications with different OS support, look and feel, requirements, etc., such that some applications 146 provide interactive entry of the topics to be voted on via a user interface (UI) so that the voter can adjust his entry to conform to the topics existing in the database, and some applications 147 provide free-form entry of the topics to be voted on, so that the voter does not have an opportunity to conform their entry to the topics existing in the database (e.g., smart TV app, browser extension, a website widget, etc.) as discussed below), web browsers configured for various device 140 operating systems and/or configurations 148, or any other communication protocols and/or programs. Data, which may include votes, sent by the devices 140 may be received by one or more servers, such as a vote server 110 in communication with a vote database 111, a parser server 120 in communication with a parser database 121, and/or a web server 130 in communication with a web database 131. Features and functions of these devices 140, servers 110, 120, 130, and databases 111, 121, 131 are described in greater detail below.

FIGS. 1B-1E show a network according to an embodiment of the invention. As shown in FIG. 1B, votes may be received from a variety of sources, such as publishers, apps, websites, SMS messages, widgets (e.g., Java or Flash elements embedded in websites or programs), emails, USSD messages, etc. The votes may be routed to one or more data centers via the Internet or another network (e.g., via the DNS web service shown in FIGS. 1B-1E). Data centers may handle votes based on geographic proximity and/or may perform load balancing. For example, large numbers of votes may be received during events of broad interest such as sporting events or political speech broadcasts, so the data centers may perform auto scaling. At least one of the data centers may be accessible by editors and/or translators who may supply topics for voting, evaluate user input topics for possible inclusion as voting topics, and/or to match entries with synonymous items so the voting may be aggregated for clarity and precision. At least one of the data centers may provide voting results as votes on a topic are collected. Those of ordinary skill in the art will appreciate that the network shown is an example only, and that any appropriate network configuration may be used to receive and process votes. Example devices 140 may include a memory interface, one or more data processors, image processors, and/or central processing units, and a peripherals interface. The memory interface, the one or more processors, and/or the peripherals interface may be separate components or may be integrated in one or more integrated circuits. The various components in the device 140 may be coupled by one or more communication buses or signal lines.

Sensors, devices, and subsystems may be coupled to the peripherals interface to facilitate multiple functionalities. For example, a motion sensor, a light sensor, and a proximity sensor may be coupled to the peripherals interface to facilitate orientation, lighting, and proximity functions. Other sensors may also be connected to the peripherals interface, such as a global navigation satellite system (GNSS) (e.g., GPS receiver), a temperature sensor, a biometric sensor, magnetometer, or other sensing device, to facilitate related functionalities.

A camera subsystem and an optical sensor, e.g., a charged coupled device (CCD) or a complementary metal-oxide semiconductor (CMOS) optical sensor, may be utilized to facilitate camera functions, such as recording photographs and video clips. The camera subsystem and the optical sensor may be used to collect images of a user to be used during authentication of a user, e.g., by performing facial recognition analysis.

Communication functions may be facilitated through one or more wireless communication subsystems, which can include radio frequency receivers and transmitters and/or optical (e.g., infrared) receivers and transmitters. For example, the BTLE and/or WiFi communications described above may be handled by wireless communication subsystems. The specific design and implementation of the communication subsystems may depend on the communication network(s) over which the device 140 is intended to operate. For example, the device 140 may include communication subsystems designed to operate over a GSM network, a GPRS network, an EDGE network, a WiFi or WiMax network, and a Bluetooth™ network. In particular, the wireless communication subsystems may include hosting protocols such that the device 140 can communicate with servers and/or other devices as described herein.

An audio subsystem may be coupled to a speaker and a microphone 830 to facilitate voice-enabled functions, such as speaker recognition, voice replication, digital recording, and telephony functions. The audio subsystem may be configured to facilitate processing voice commands, voiceprinting, and voice authentication, for example.

The I/O subsystem may include a touch-surface controller and/or other input controller(s). The touch-surface controller may be coupled to a touch surface. The touch surface and touch-surface controller may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) may be coupled to other input/control devices, such as one or more buttons, rocker switches, thumb-wheel, infrared port, USB port, and/or a pointer device such as a stylus. The one or more buttons may include an up/down button for volume control of the speaker and/or the microphone.

In one implementation, a pressing of the button for a first duration may disengage a lock of the touch surface; and a pressing of the button for a second duration that is longer than the first duration may turn power to the device 140 on or off. Pressing the button for a third duration may activate a voice control, or voice command, module that enables the user to speak commands into the microphone to cause the device to execute the spoken command. The user may customize a functionality of one or more of the buttons. The touch surface can, for example, also be used to implement virtual or soft buttons and/or a keyboard.

In some implementations, the device 140 may present recorded audio and/or video files, such as MP3, AAC, and MPEG files. In some implementations, the device 140 may include the functionality of an MP3 player, such as an iPod™. The device 140 may, therefore, include a 36-pin connector that is compatible with the iPod. Other input/output and control devices may also be used.

The memory interface may be coupled to memory. The memory may include high-speed random access memory and/or non-volatile memory, such as one or more magnetic disk storage devices, one or more optical storage devices, and/or flash memory (e.g., NAND, NOR). The memory may store an operating system, such as Darwin, RTXC, LINUX, UNIX, OS X, WINDOWS, or an embedded operating system such as VxWorks.

The operating system may include instructions for handling basic system services and for performing hardware dependent tasks. In some implementations, the operating system may be a kernel (e.g., UNIX kernel). In some implementations, the operating system may include instructions for performing voice authentication. For example, the operating system may implement some of the functions of the device 140 described herein.

The memory may also store communication instructions to facilitate communicating with one or more additional devices, one or more computers and/or one or more servers. The memory may include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GNSS/Navigation instructions to facilitate GNSS and navigation-related processes and instructions; and/or camera instructions to facilitate camera-related processes and functions. The memory may store instructions specific to facilitating the processes described herein.

The memory may also store other software instructions, such as web video instructions to facilitate web video-related processes and functions; and/or web shopping instructions to facilitate web shopping-related processes and functions. In some implementations, the media processing instructions may be divided into audio processing instructions and video processing instructions to facilitate audio processing-related processes and functions and video processing-related processes and functions, respectively.

Each of the above identified instructions and applications may correspond to a set of instructions for performing one or more functions described herein. These instructions need not be implemented as separate software programs, procedures, or modules. The memory may include additional instructions or fewer instructions. Furthermore, various functions of the device 140 may be implemented in hardware and/or in software, including in one or more signal processing and/or application specific integrated circuits.

Example servers 110, 120, 130 may be implemented on any electronic device that runs software applications derived from compiled instructions, including without limitation personal computers, servers, smart phones, media players, electronic tablets, game consoles, email devices, etc. In some implementations, servers 110, 120, 130 may include one or more processors, one or more input devices, one or more display devices, one or more network interfaces, and one or more computer-readable mediums. Each of these components may be coupled by a bus.

Display devices may be any known display technology, including but not limited to display devices using Liquid Crystal Display (LCD) or Light Emitting Diode (LED) technology.

Processor(s) may use any known processor technology, including but not limited to graphics processors and multi-core processors. Input devices may be any known input device technology, including but not limited to a keyboard (including a virtual keyboard), mouse, track ball, and touch-sensitive pad or display. Busses may be any known internal or external bus technology, including but not limited to ISA, EISA, PCI, PCI Express, NuBus, USB, Serial ATA or FireWire. Computer-readable mediums may be any medium that participates in providing instructions to processor(s) for execution, including without limitation, non-volatile storage media (e.g., optical disks, magnetic disks, flash drives, etc.), or volatile media (e.g., SDRAM, ROM, etc.). Computer-readable medium may include various instructions for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device; sending output to display device; keeping track of files and directories on computer-readable medium; controlling peripheral devices (e.g., disk drives, printers, etc.) which can be controlled directly or through an I/O controller; and managing traffic on bus. Network communications instructions may establish and maintain network connections (e.g., software for implementing communication protocols, such as TCP/IP, HTTP, Ethernet, etc.).

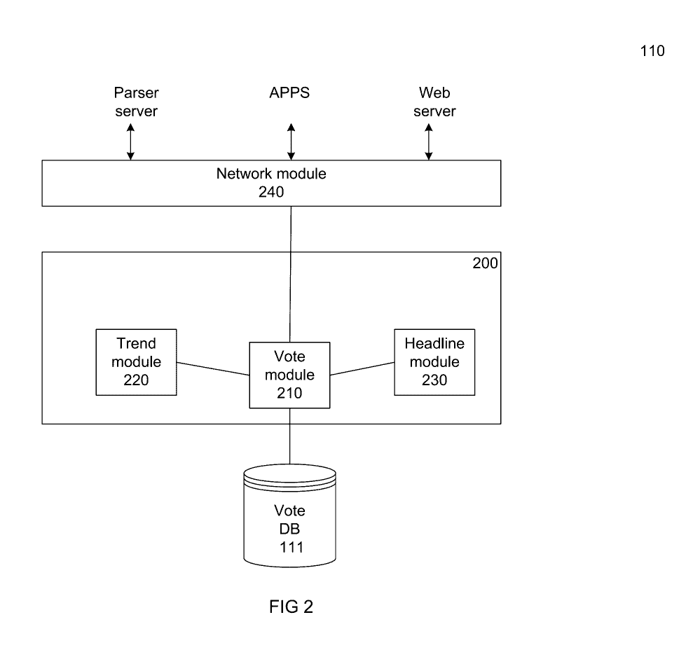

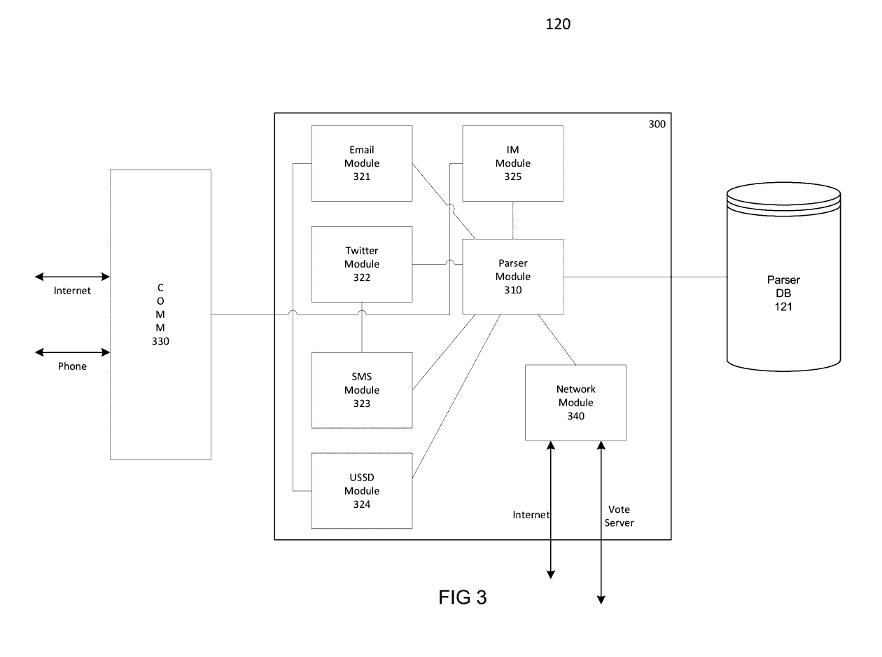

Application(s) may use or implement the server processes described herein. The server processes may also be implemented in server 110, 120, 130 operating systems. While FIGS. 1B-1E provide a specific hardware example of a network for receiving and analyzing votes, FIGS. 2-3 illustrate modules which may be present in any or all of the one or more data centers and that may perform the voting related tasks described below.

FIG. 2 is a vote server 110 and vote database 111 according to an embodiment of the invention. The vote server 110 may include a network module 240 for receiving voting data from other servers and/or user devices. A user device may be any device that can exchange data with the vote server 110 (e.g., a PC, laptop, smartphone, tablet, or any other computing device). For example, in the app-based voting described below, vote data may be clearly linked to a topic and a yes or no opinion on the topic before it is sent to the vote server 110. Also, as described below, votes entered in a free-form manner (e.g., via email, text, speech, or any other manner) may be parsed by the parser server 120 and then sent to the vote server 110 for counting. A vote module 210 may take in the data from the network and identify and/or count votes within the data. A trend module 220 may generate voting results data, and a headline module 230 may identify topics that may inspire voting.

FIG. 3 is a parser server 120 and parser database 121 according to an embodiment of the invention. When voting is performed in a manner where the voter cannot see if their entry matches the topics in the existing database (e.g., entered in a free-form manner via Twitter, email, SMS, USSD, etc.), the voting data may be received by the parser server 120 and analyzed. For example, emails may be handled by the email module 321, tweets by the Twitter module 322, SMS messages by the SMS module 323, USSD messages by the USSD module 324, instant messages by the IM module 325, etc. These modules may pull the message data from the messages and pass it to the parser module 310, which may identify the topic and vote from the messages. The network module 340 may pass the identified topic and vote to the vote server 110 for counting.

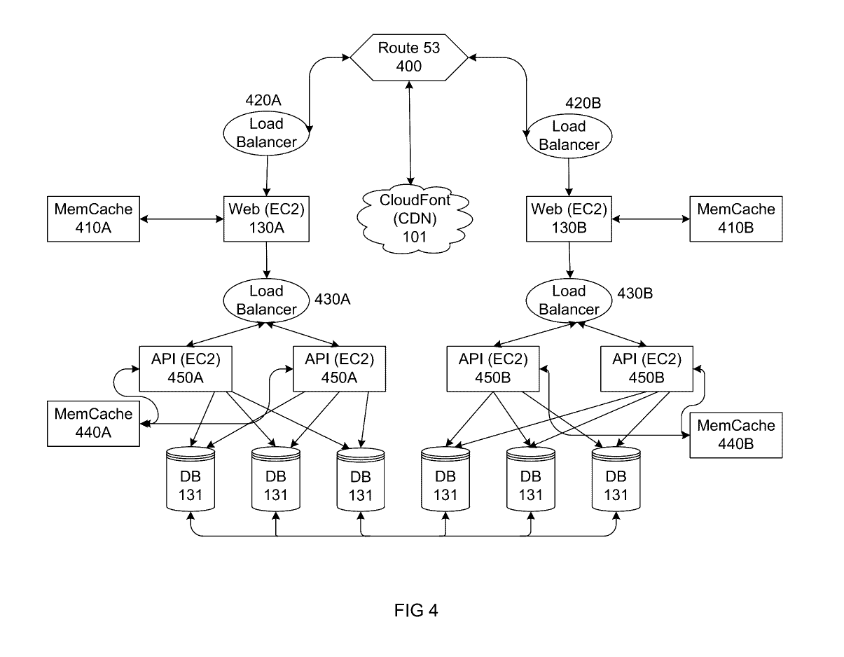

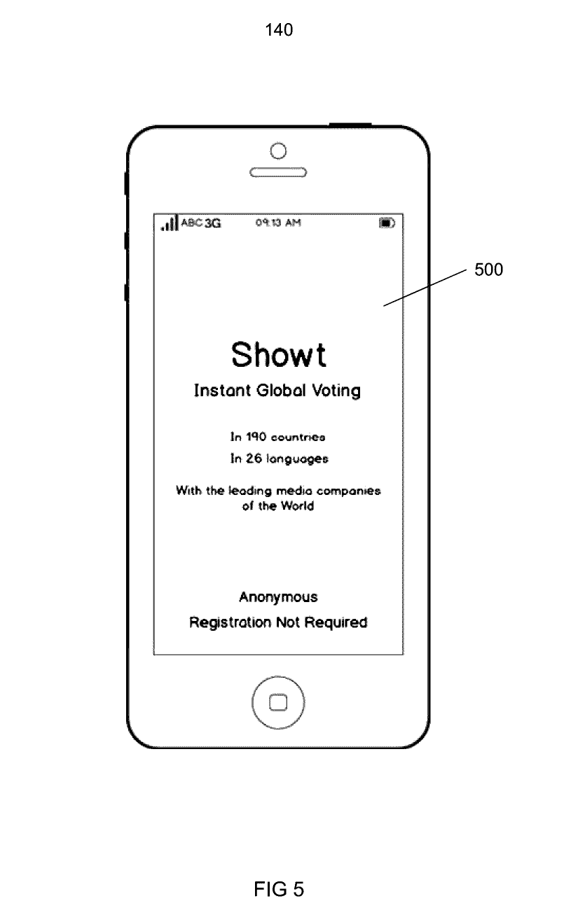

FIG. 4 is a server network according to an embodiment of the invention. The server network of FIG. 4 may be used as the vote server 110 and/or parser server 120 and/or as one or more elements of the data center of FIGS. 1B-1E. In this example, data may be received via network 101 and passed to individual web servers 130A/130B based on decisions made by load balancers 420A/420B. Each web server 130A/130B may have further internal load balancers 430A/430B, APIs to provide one or more of the modules described above 450A/450B, and databases 131 and memory 410A/410B/440A/440B. Those of ordinary skill in the art will appreciate that the network shown is an example only, and that any appropriate network configuration may be used to receive and process votes.

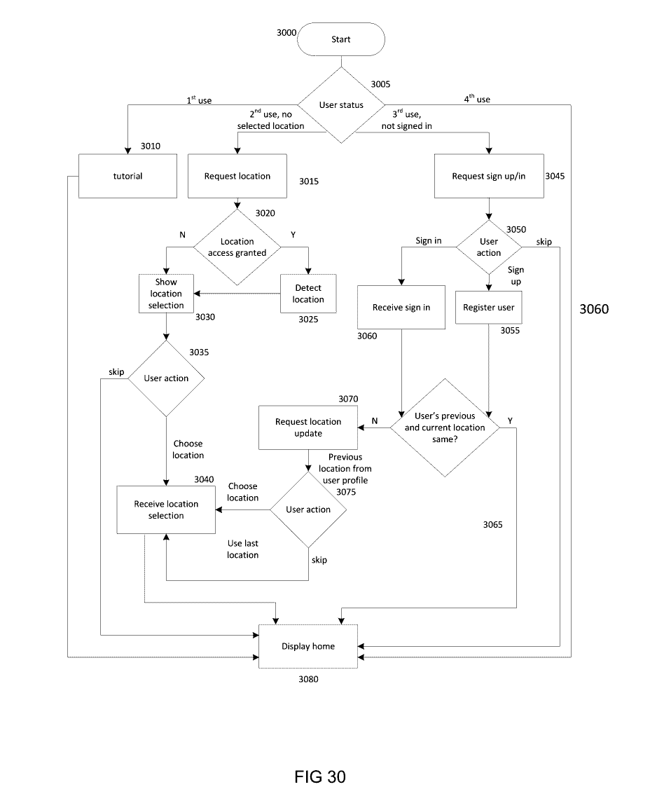

FIGS. 5-29 are screenshots of a voting UI that allows the voter to choose from items in the existing database of topics according to an embodiment of the invention, and FIGS. 30-39 are voting processing methods according to an embodiment of the invention. Each device 140 may present a UI to a user that may enable the user to generate votes and transmit them to the vote server 110. The vote server 110 may process the votes, for example by determining to which topic a vote pertains and/or whether the vote is a “yes” or “no” and adding the vote to the “yes” or “no” tally for the topic. In some voting embodiments, the UI may present specific vote topics and “yes” or “no” options to a user. When the device 140 sends the vote data to the vote server 110, the vote data may include an indication of the topic and vote choice. The vote server 110 may analyze the received data and determine from the indication how to tally the vote. The voting processing methods of FIGS. 30-39 are therefore presented as methods performed by the device 140. However, in some embodiments, the vote server 110 or other servers may perform some or all of the processes. While the example screenshots of FIGS. 5-29 are presented in English, the UI may be displayed in any language and may include an option to choose a display language from among all available languages in the system.

FIG. 5 illustrates a UI 500 that may be a home screen for the voting application/platform. The home screen may be displayed upon launch of the application and may change to a next screen (e.g., one of the screens described below) after a period of time or upon receiving some command (e.g., a click) from the user.

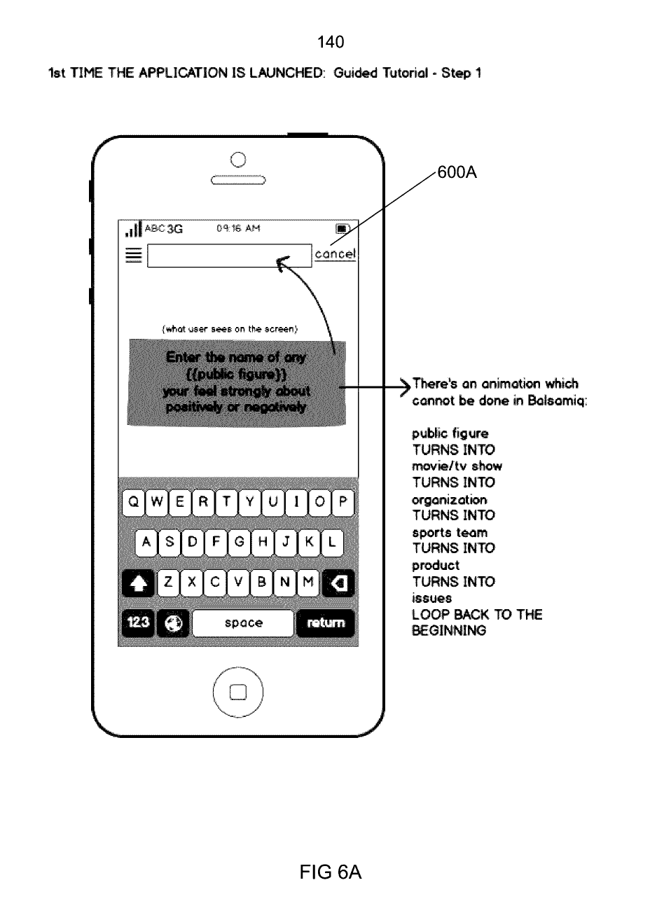

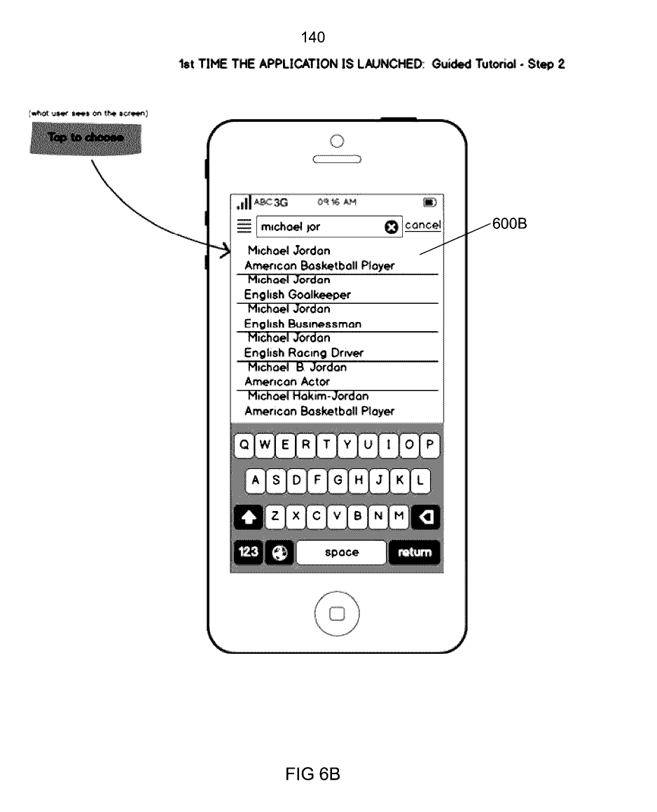

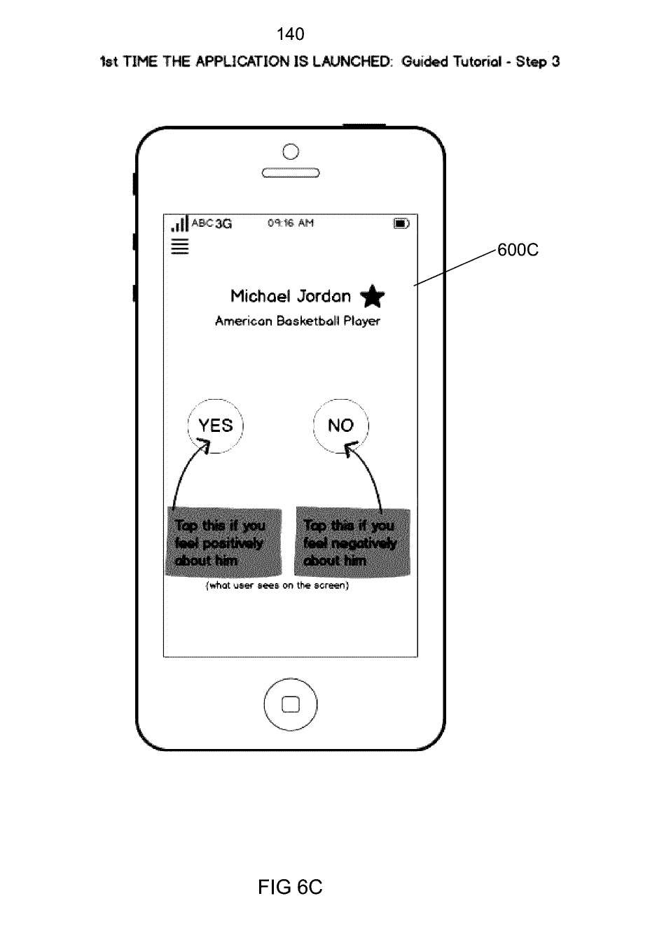

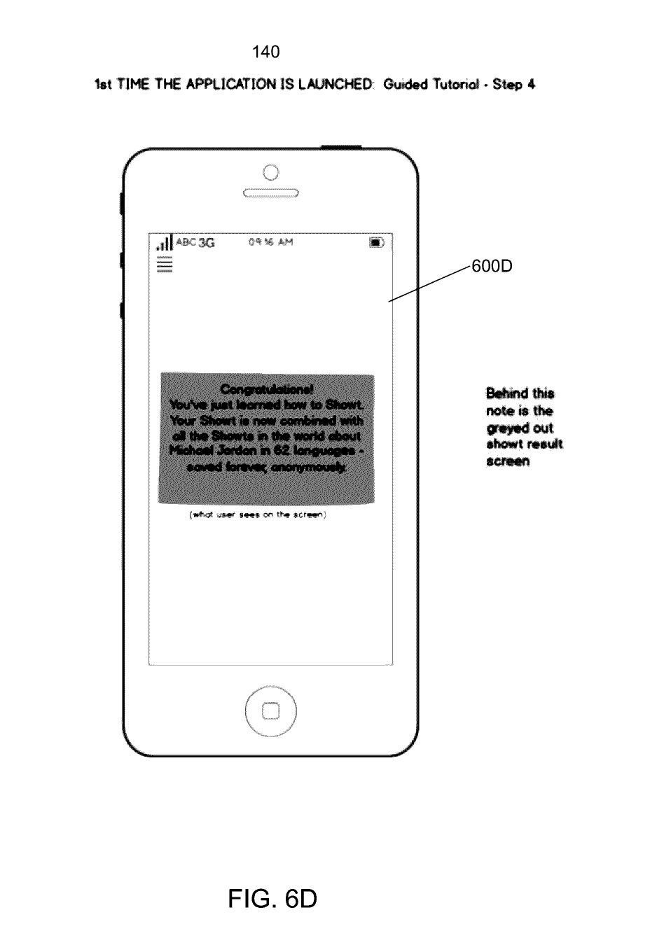

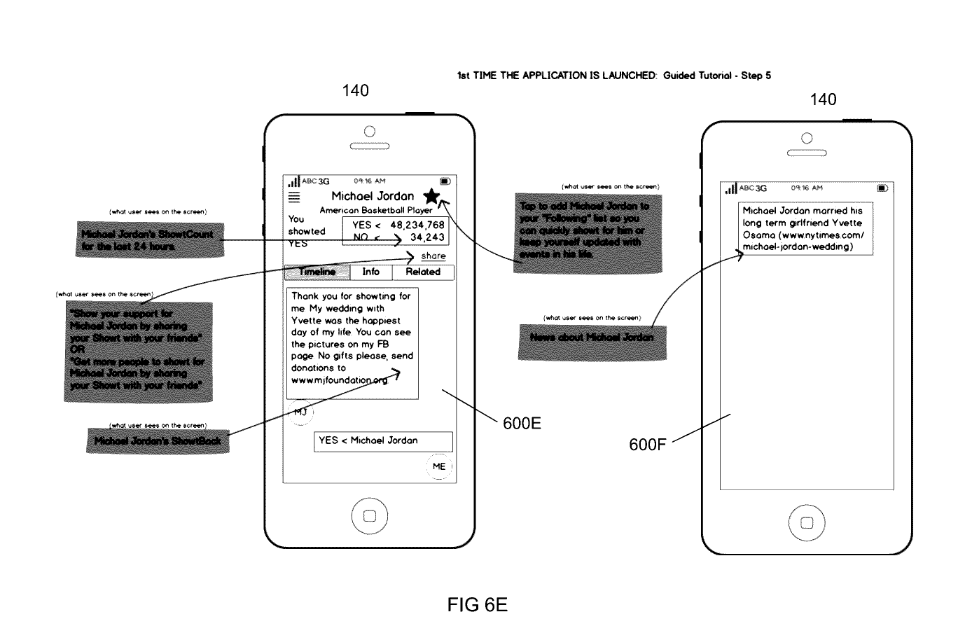

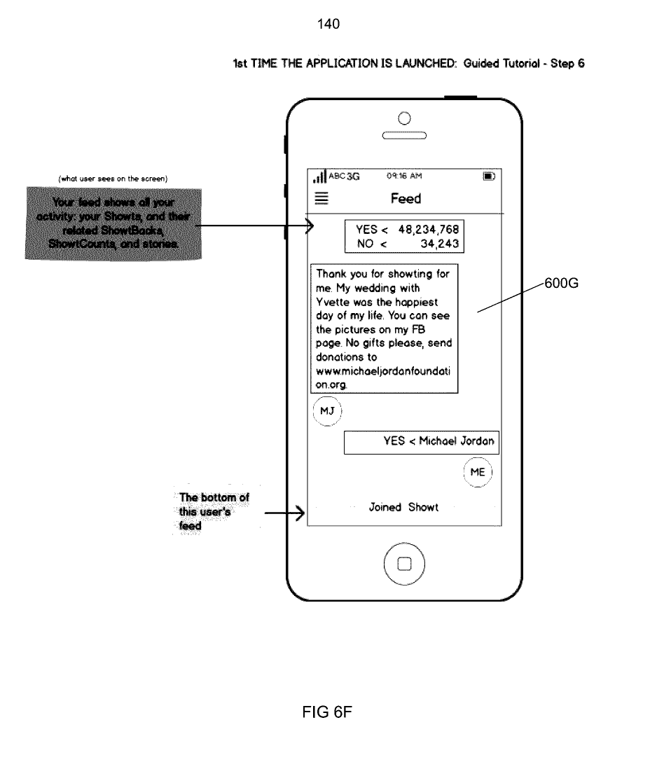

FIG. 6A illustrates a UI 600A that may be an initial screen of a guided tutorial that may be displayed when the application is launched for a first time for a user after the home screen is displayed or upon user request. The guided tutorial may include text, animation, video, and/or sound to explain the functionality of the voting user interface. FIG. 6B illustrates a UI 600B that may be a second step of a guided tutorial explaining a search feature and navigation of a list of search results generated from a user input. FIG. 6C illustrates a UI 600C that may be a third step of a guided tutorial explaining voting. FIG. 6D illustrates a UI 600D that may be a fourth step of a guided tutorial displaying a successful vote and explaining how votes are aggregated. FIG. 6E illustrates a UI 600E and UI 600F that may be a fifth step of a guided tutorial explaining target information screens such as timeline, following, information, related information, news, and the like. FIG. 6F illustrates a UI 600GD that may be a sixth step of a guided tutorial explaining an activity feed based on the search result.

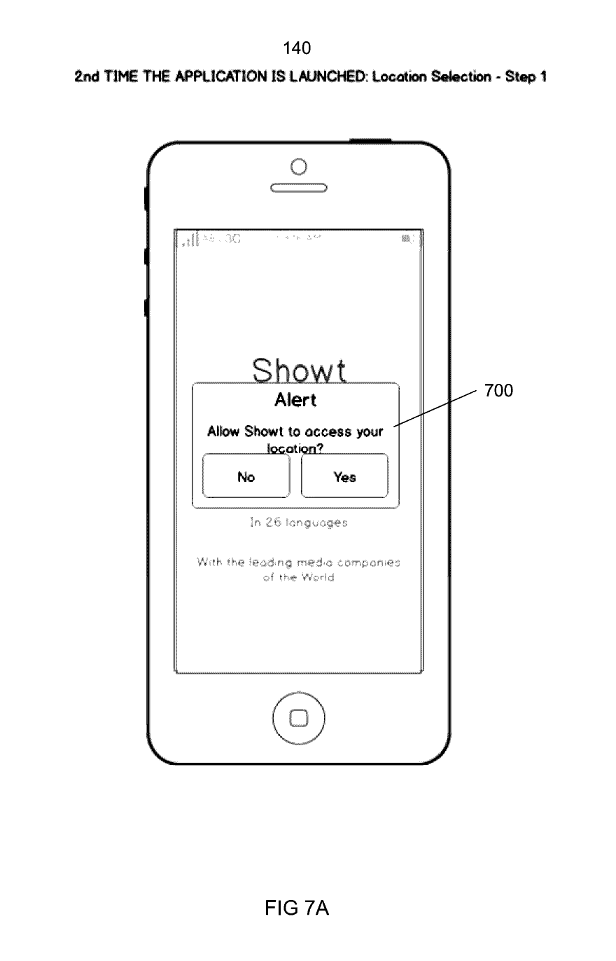

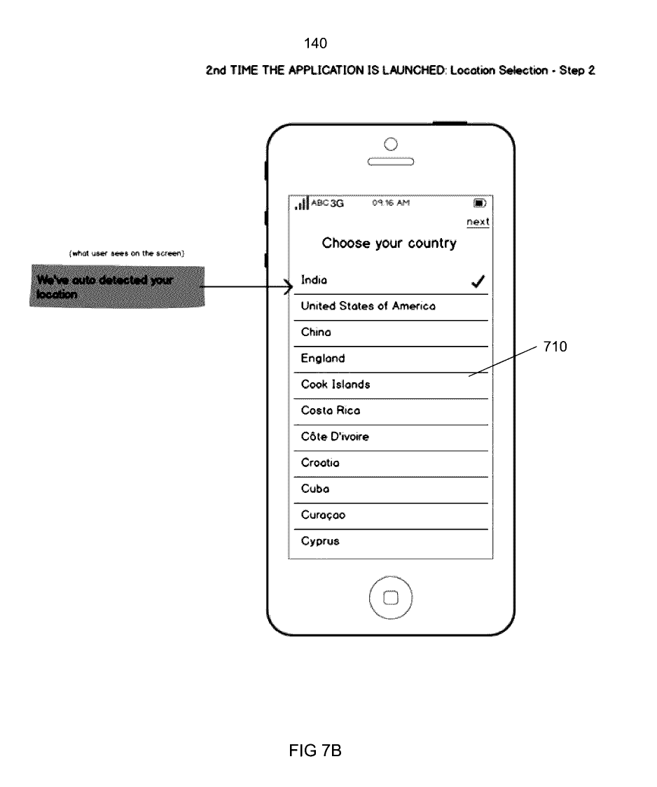

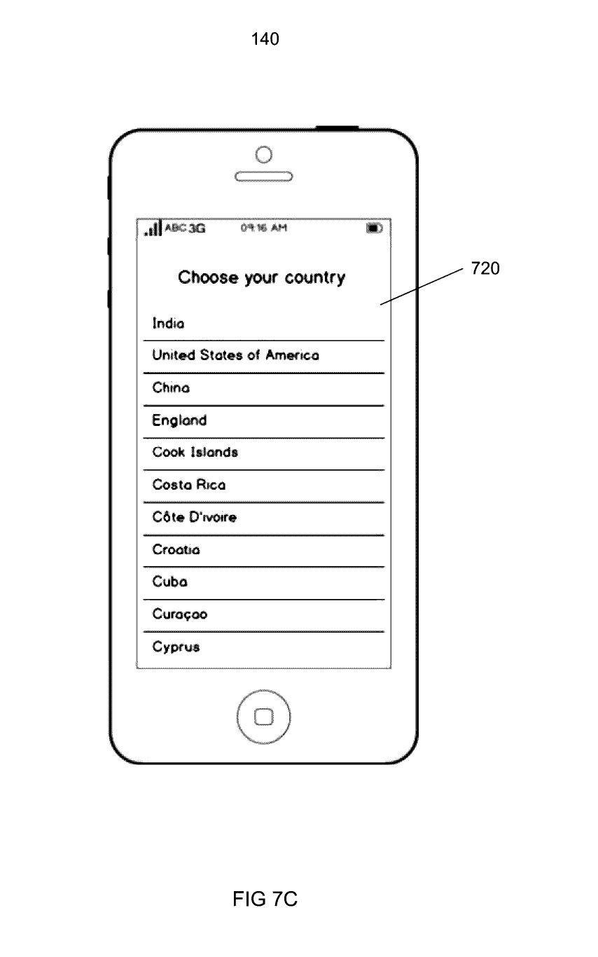

FIG. 7A illustrates a UI 700 that may be a first step of location selection that may be displayed the second time the application is launched or upon user request. The user may be prompted to grant or deny access to location information generated by the device 140 (e.g., via GPS location). FIG. 7B illustrates a UI 710 that may be a second step of location selection with auto-detection of country selection. For example, if permission to access location information is granted, the country in which the device 140 is located may be detected and displayed. The user may be able to confirm the country or select a different country. FIG. 7C illustrates a UI 720 that may allow a user to select the country when permission to access location information is not granted. The country selection may cause the UI to default to a language in some embodiments. For example, a selection of Italy as the location may cause information (e.g., voting topics, voting results, advertisements, messages, feed activity, etc.) to be displayed in Italian, while a selection of France may cause the information to be displayed in French.

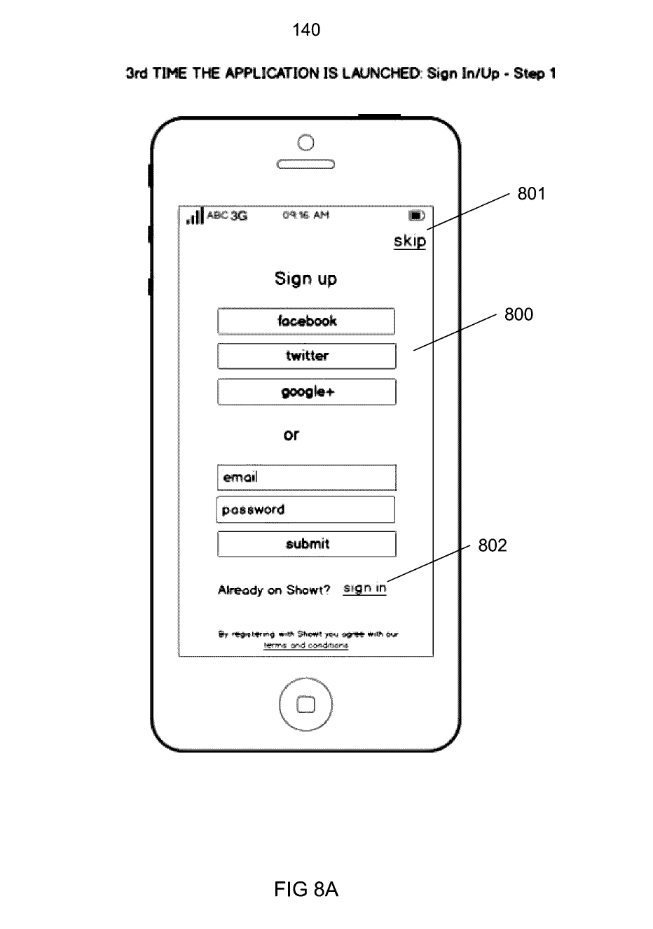

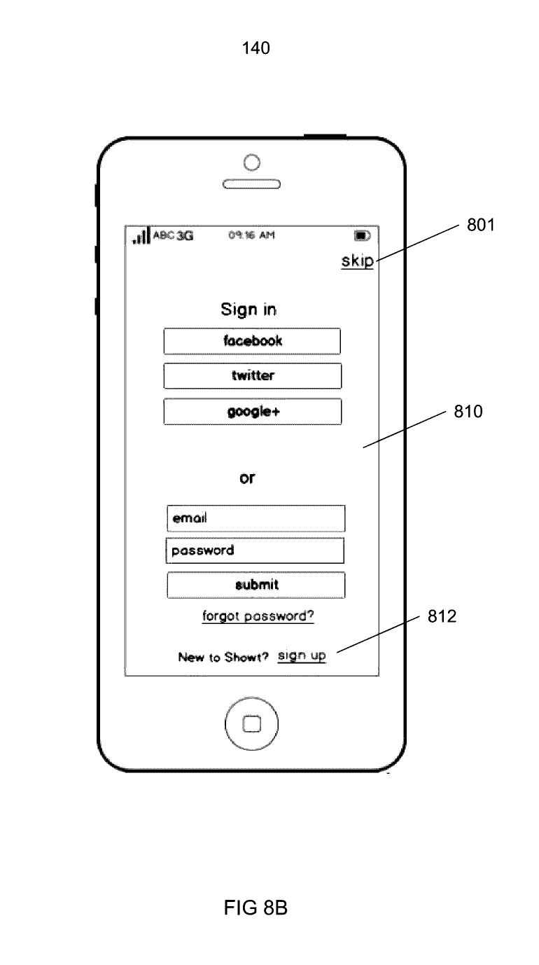

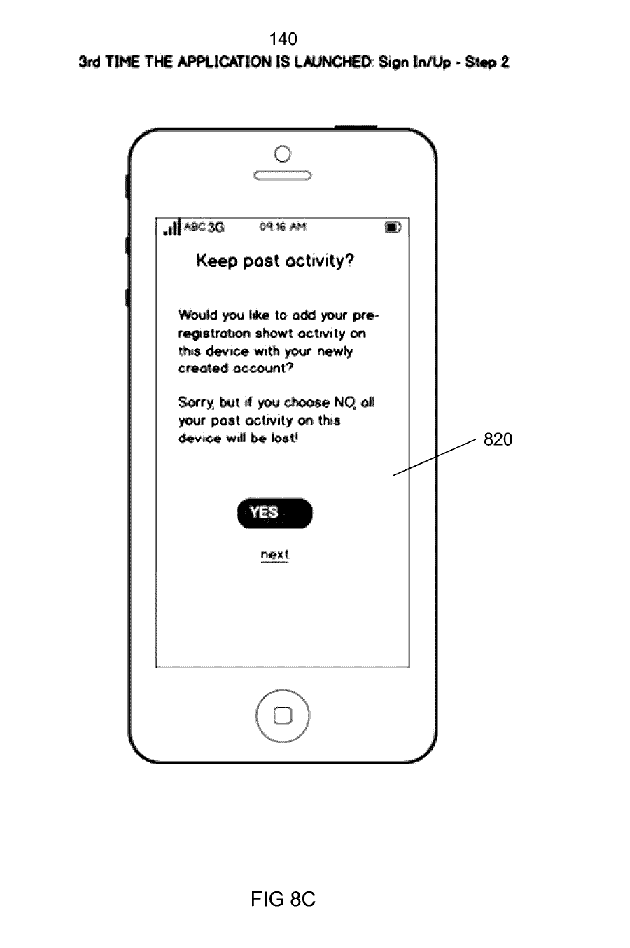

FIG. 8A illustrates a UI 800 that may be a first step of sign-up/sign-in that may be displayed the third time the application is launched or upon user request. UI 800 may include a skip option 801 and a sign-in option 802 to allow users who do not wish to sign up or who already have an account to bypass the sign-up process. The user may sign up via credentials from another platform such as a social media network or register to the application platform itself. FIG. 8B illustrates a UI 810 where the user is prompted to sign-in. UI 810 may include a skip option 801 and a sign-up option 812 for users who do not wish to sign up or who have reached this screen without having an account. The user may sign in via credentials from another platform such as a social media network or an account with the application platform itself. FIG. 8C illustrates a UI 820 that may be a second step of sign-up/sign-in wherein the user may be prompted to grant access to past activity such as votes cast before registration and/or other user information.

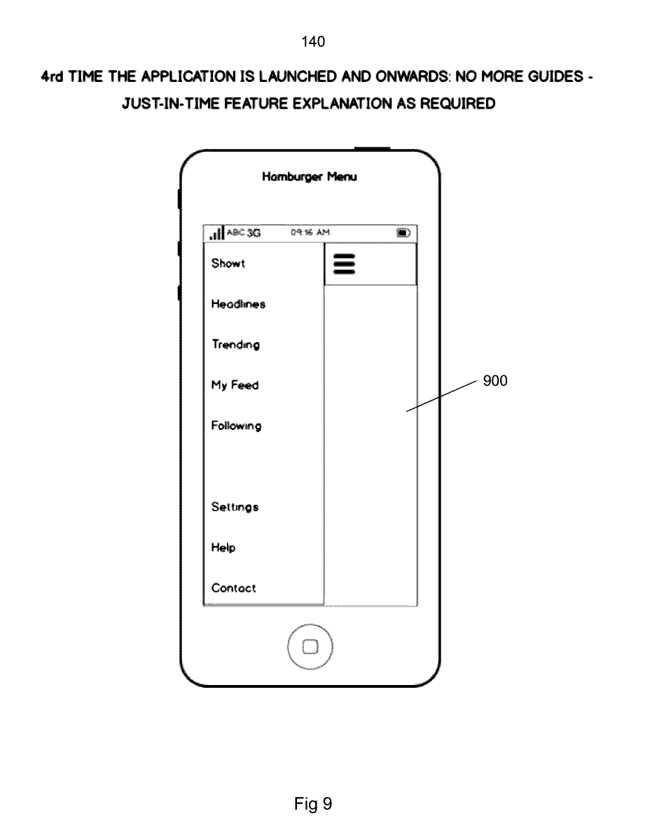

FIG. 9 illustrates a UI 900 that may be presented the fourth time the application is launched and subsequently thereafter. A guided tutorial may no longer be available in some embodiments, however just-in-time feature explanation for specific features may be provided.

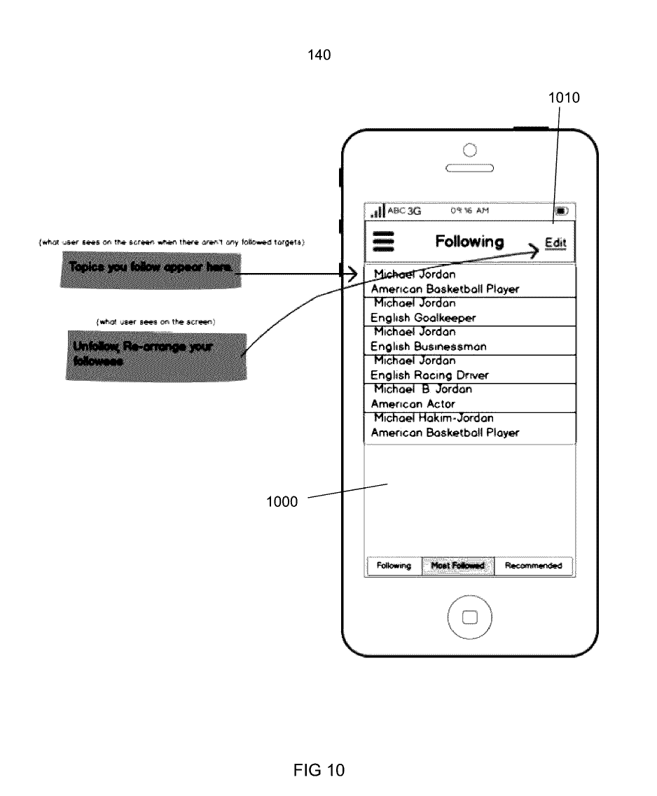

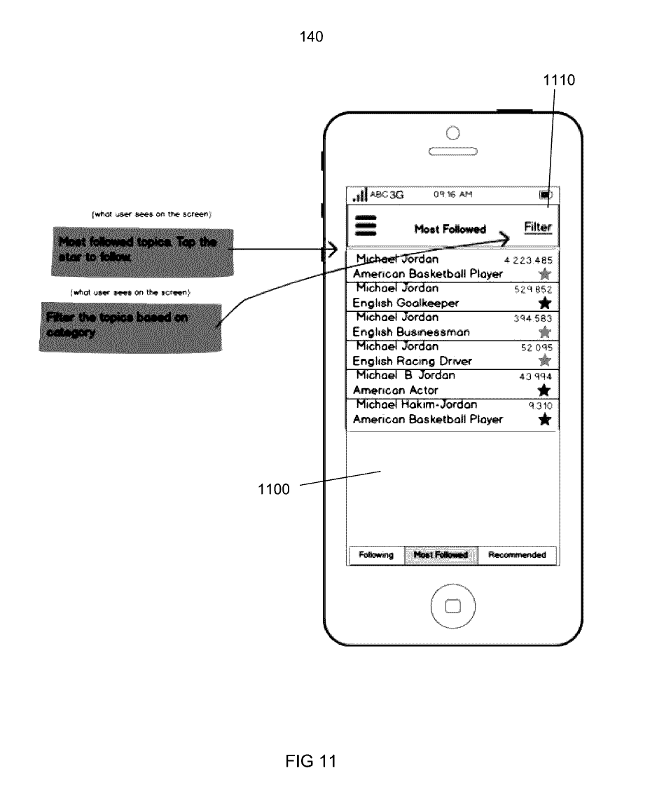

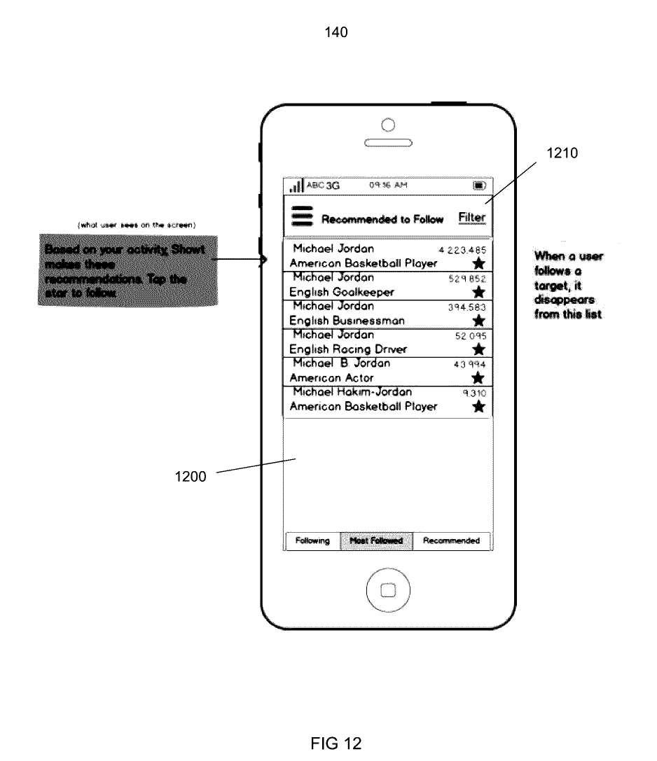

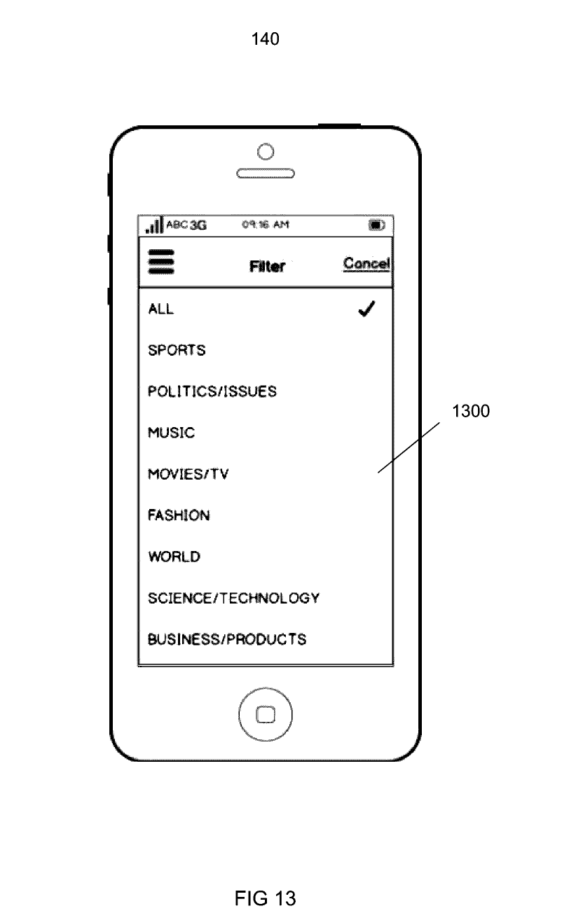

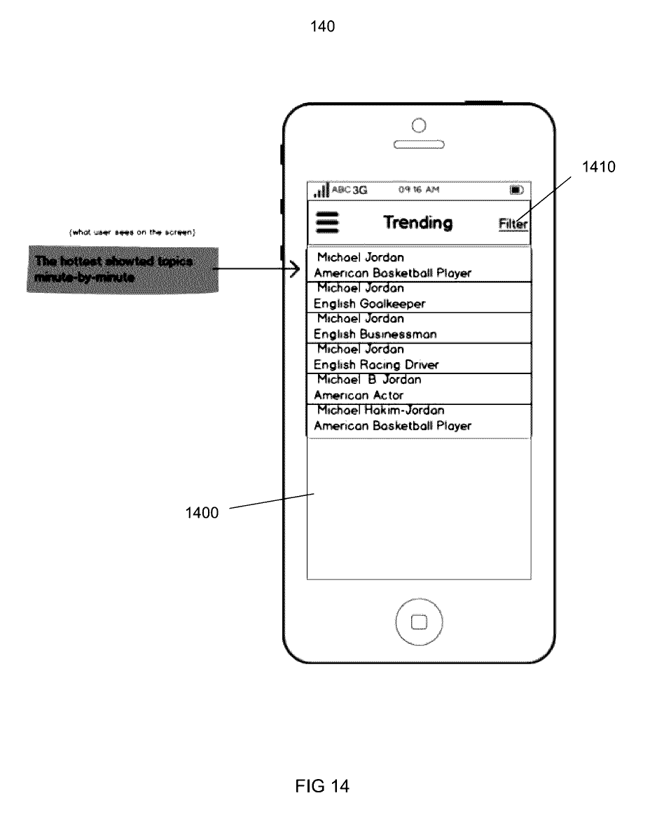

FIG. 10 illustrates one embodiment of a following UI 1000. The UI may display a list of followed targets and include an edit option 1010 to rearrange and unfollow the targets. FIG. 11 illustrates one embodiment of a most followed UI 1100. The UI may display a list of most followed targets/topics for voting along with associated details and may include a filter option 1110. FIG. 12 illustrates one embodiment of a recommended UI 1200. The UI may display a list of recommended targets/topics for voting and associated details and may include a filter 1210. FIG. 13 illustrates one embodiment of a filter UI 1300 that may allow the targets to be filtered by categories such as sports, politics, music, movies, fashion, and the like. FIG. 14 illustrates a UI 1400 that may display trending targets with an option to filter 1410 the results.

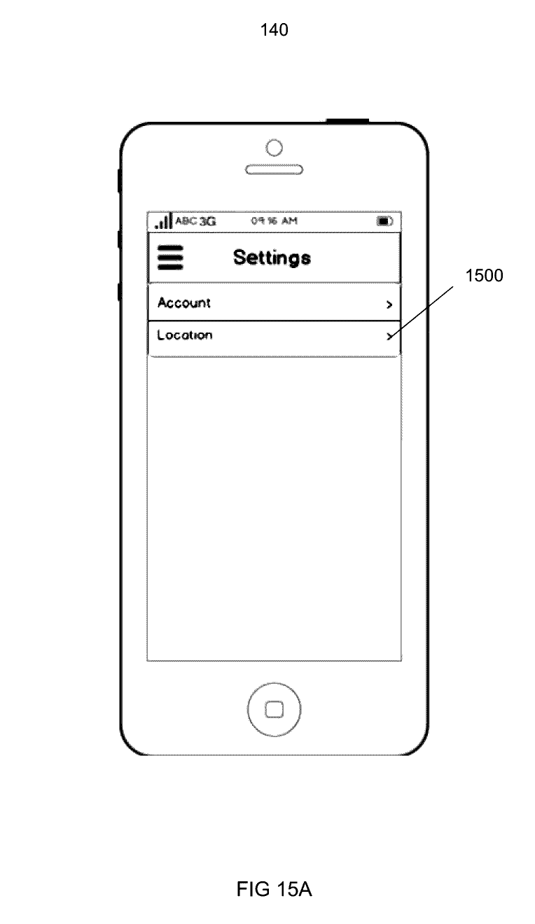

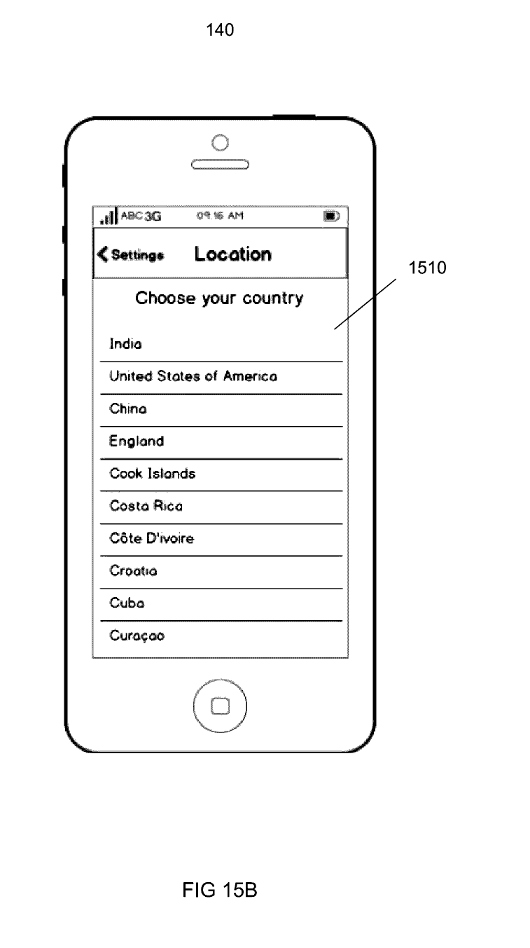

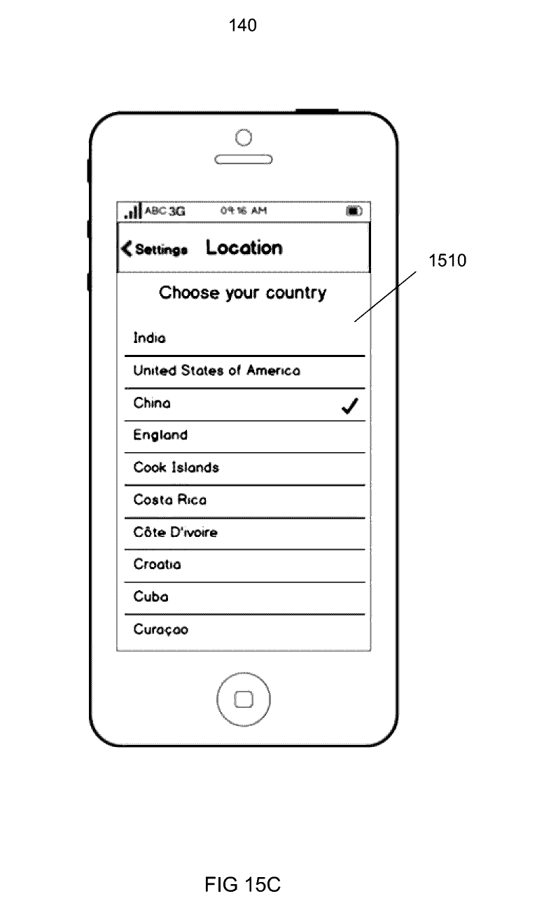

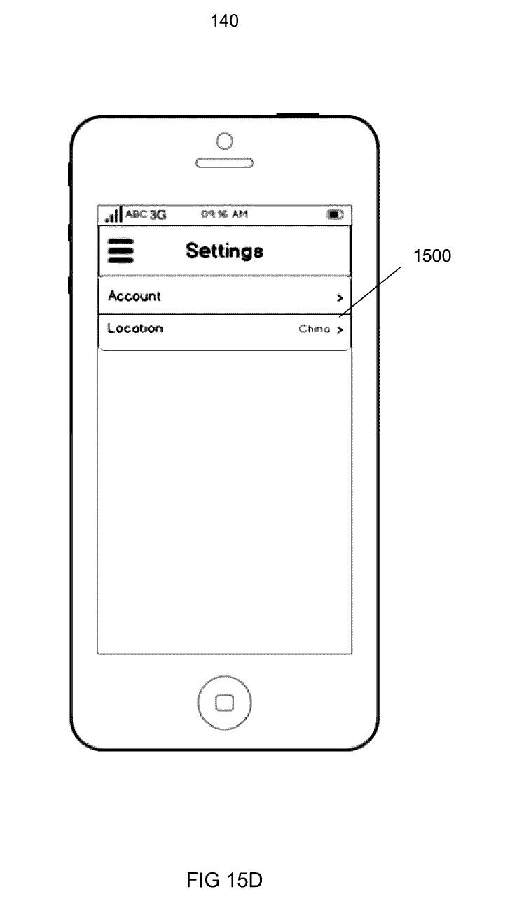

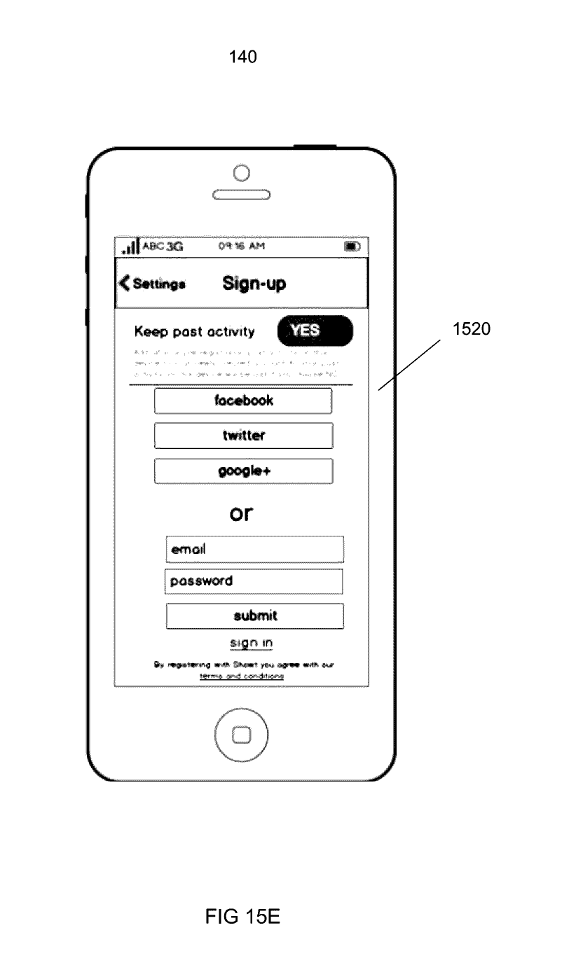

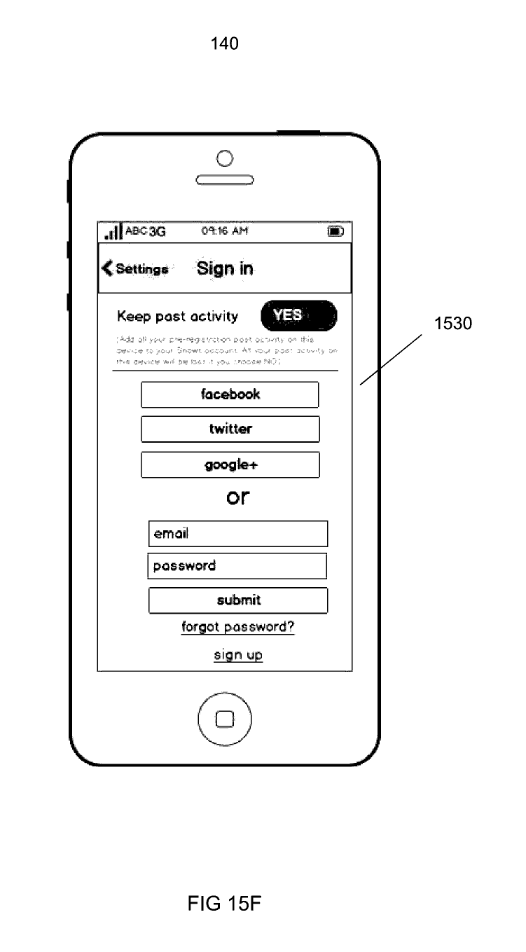

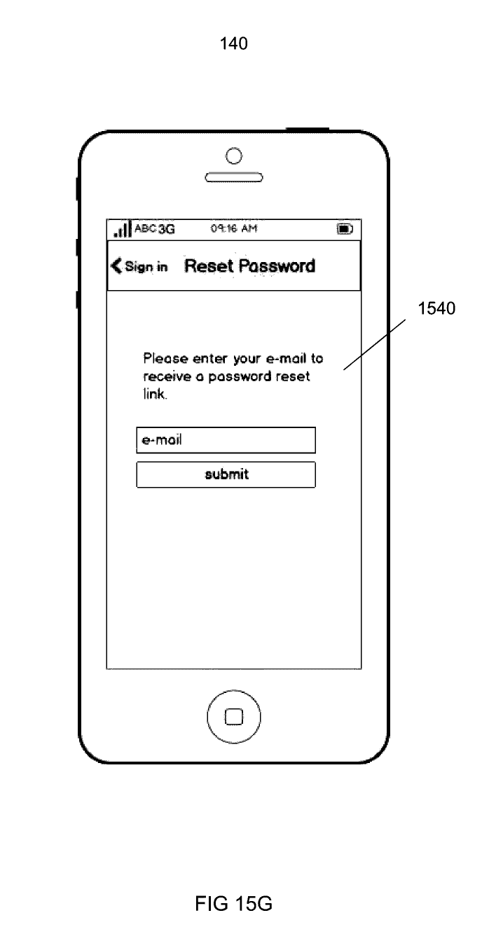

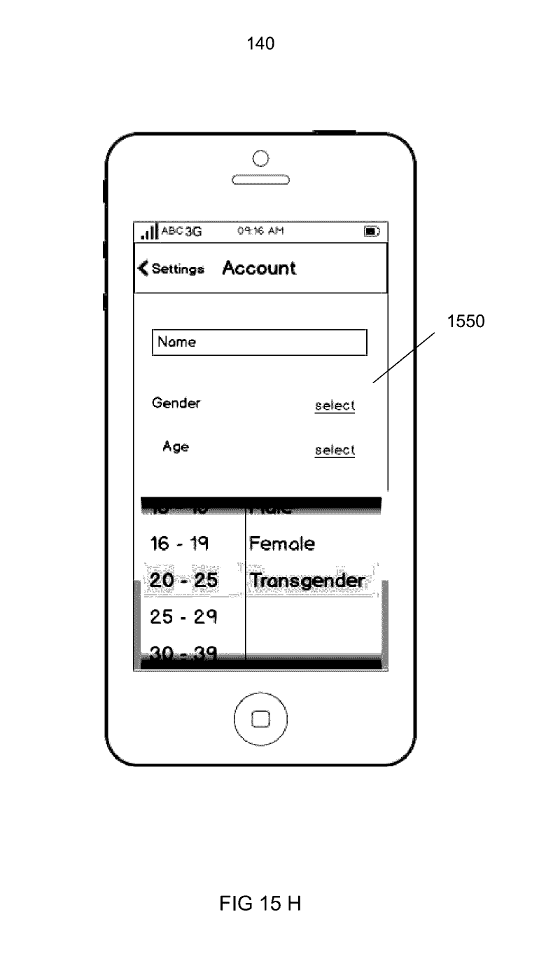

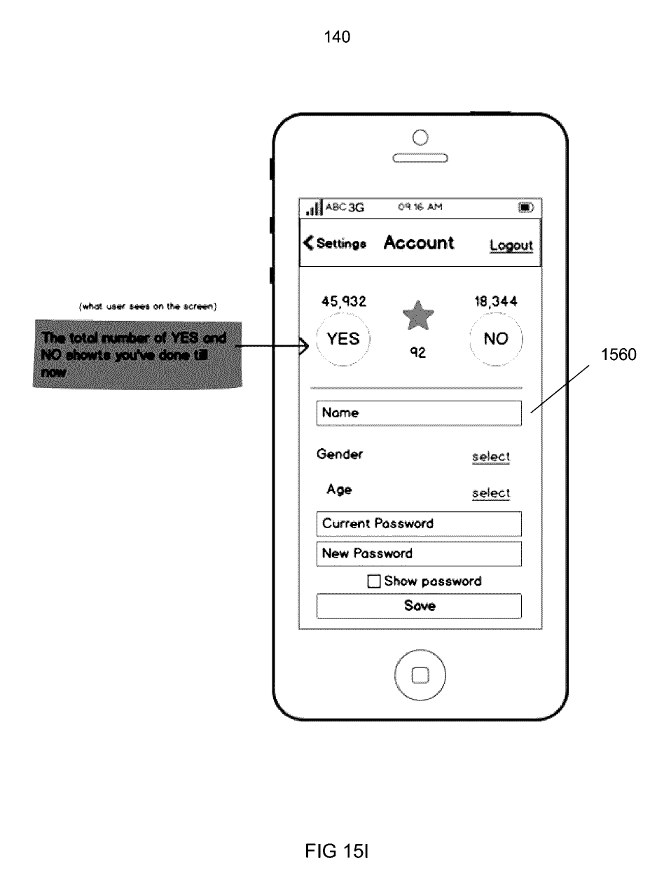

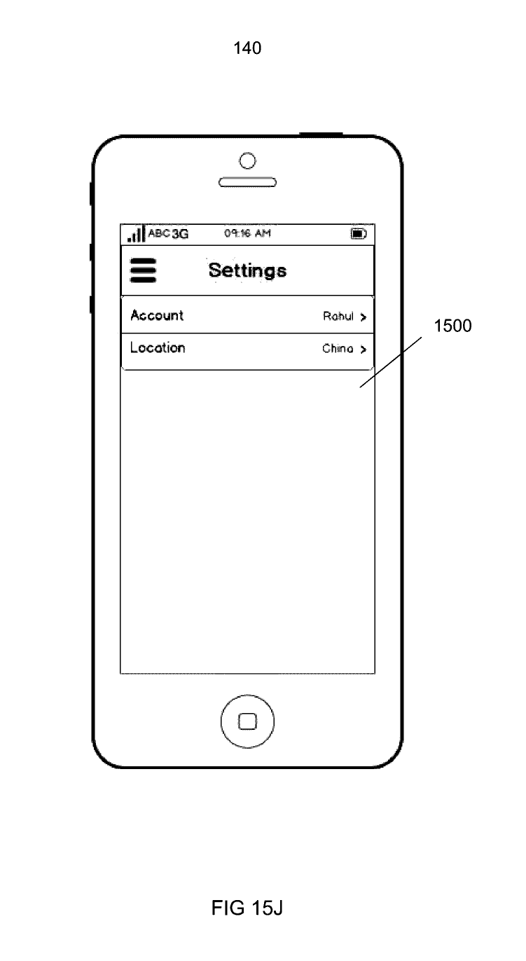

FIG. 15A illustrates one embodiment of a settings menu UI 1500 including an account and location that may be selected. Selecting the account option may allow a user to sign in/out of an account and/or change accounts. FIG. 15B illustrates one embodiment of a location access list UI 1510 for a user to select from a plurality of countries, which may be displayed when a user selects the location option in the settings menu. FIG. 15C illustrates one embodiment of a location access list UI 1510 where a country has been selected from a plurality of countries. FIG. 15D illustrates one embodiment of a settings menu UI 1500 including an account and location that may be selected where the location has been selected as described above and may now be displayed on the settings menu. FIG. 15E illustrates one embodiment where a sign-up UI 1520 may include an option to merge past activity (e.g., merge votes made before registration into the registered account). FIG. 15F illustrates one embodiment where a sign-up UI 1530 may include option to merge past activity and a forgotten password prompt. FIG. 15G illustrates one embodiment of a password reset UI 1540, wherein an email address associated with an account may be entered, which may prompt sending of a recovery email to the email address. FIG. 15H illustrates one embodiment of an account settings UI 1550 which may enable a user to review and/or modify a name, gender, age, and/or other account information. FIG. 151 illustrates one embodiment of an account settings UI 1560 which may enable a user to review and/or modify account information and view account statistics such as the total number of YES and NO votes cast by the user. FIG. 15J illustrates one embodiment of a settings menu UI 1500 that may include an account setting associated with a user and a location setting associated with a location.

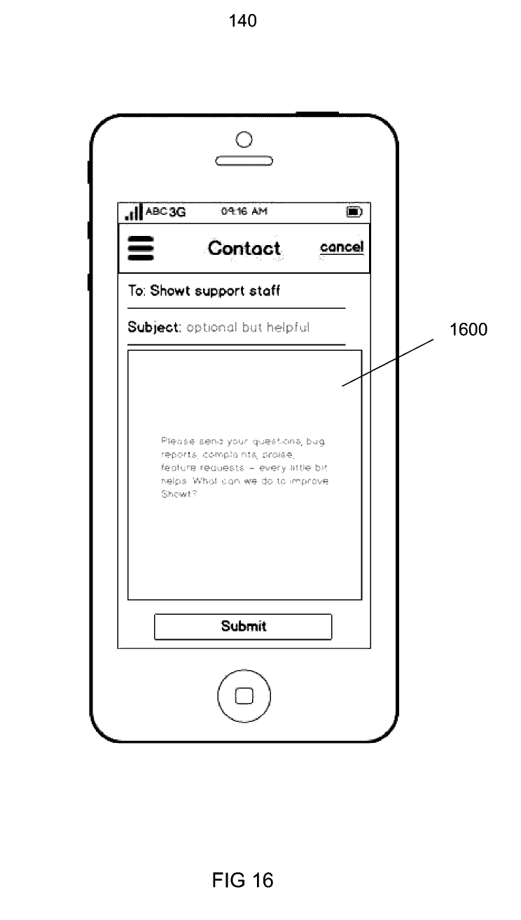

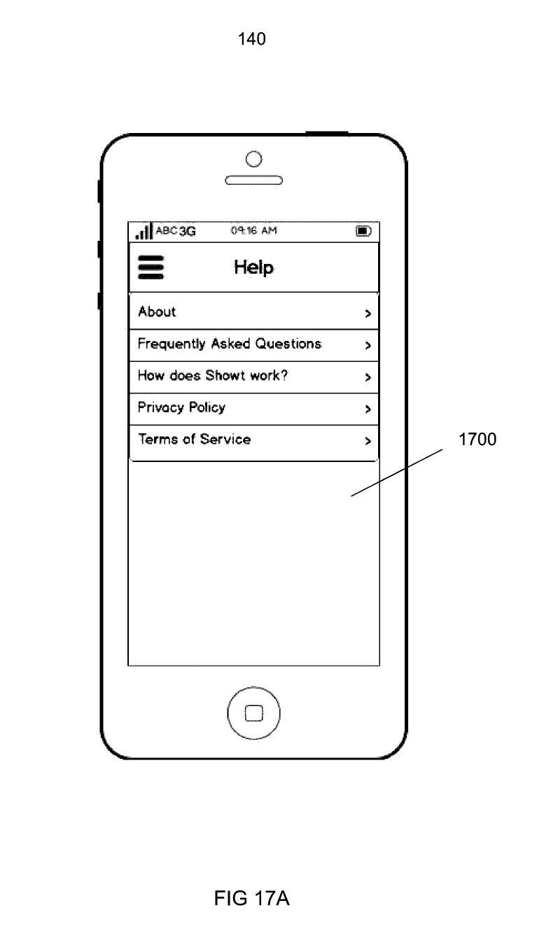

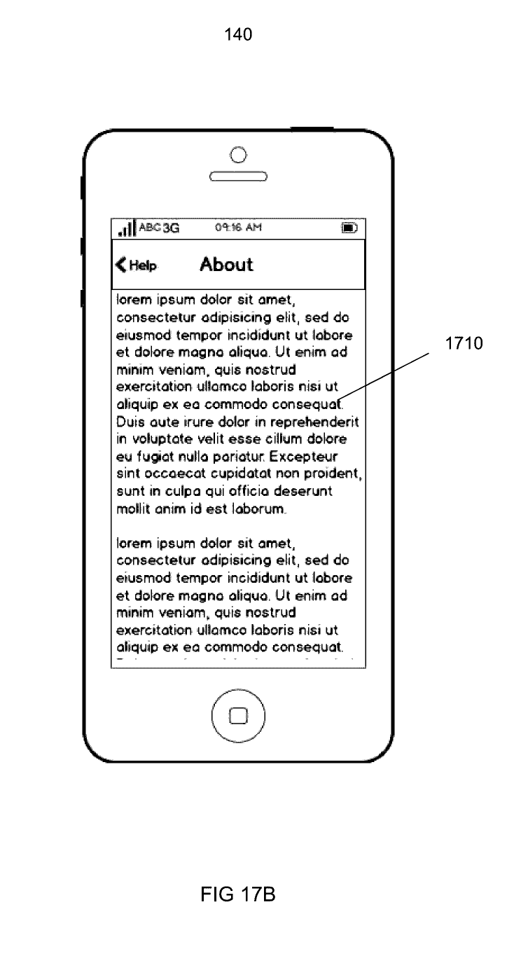

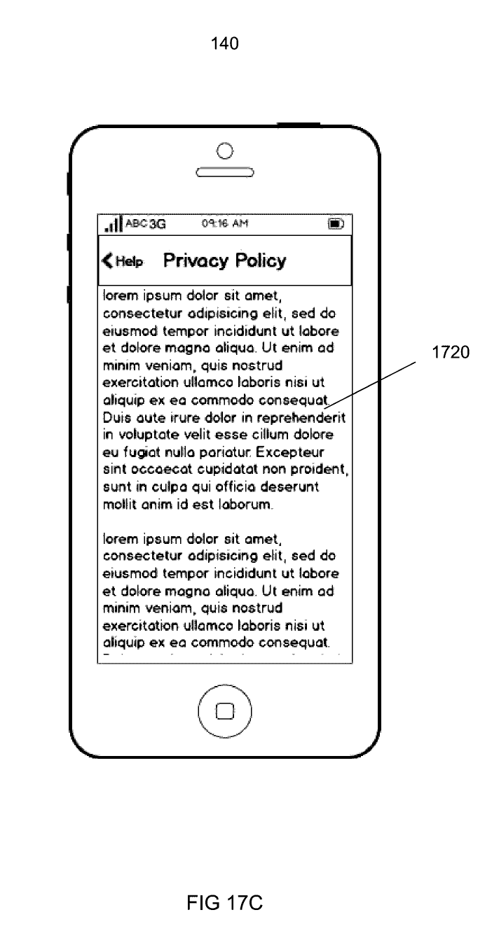

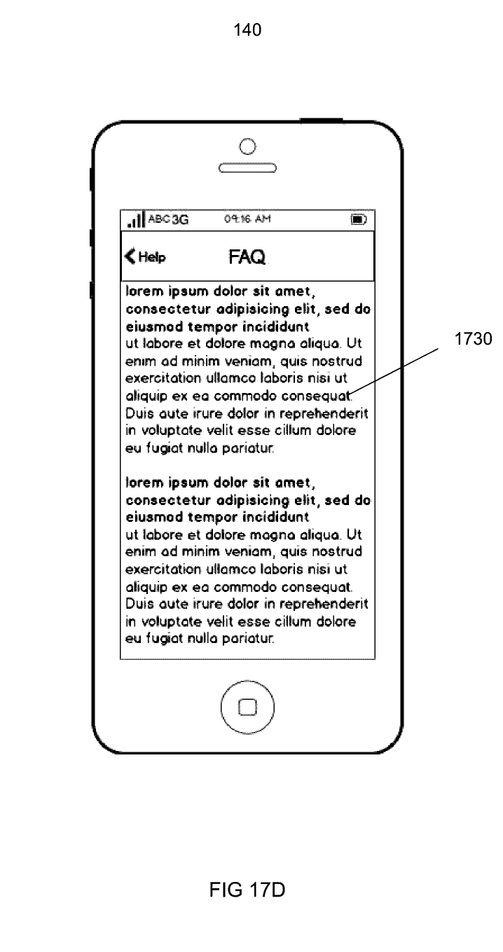

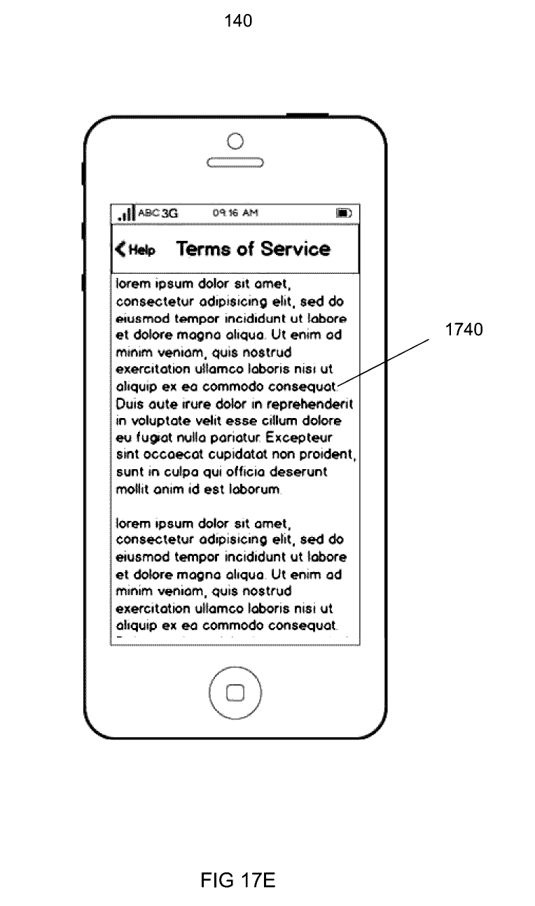

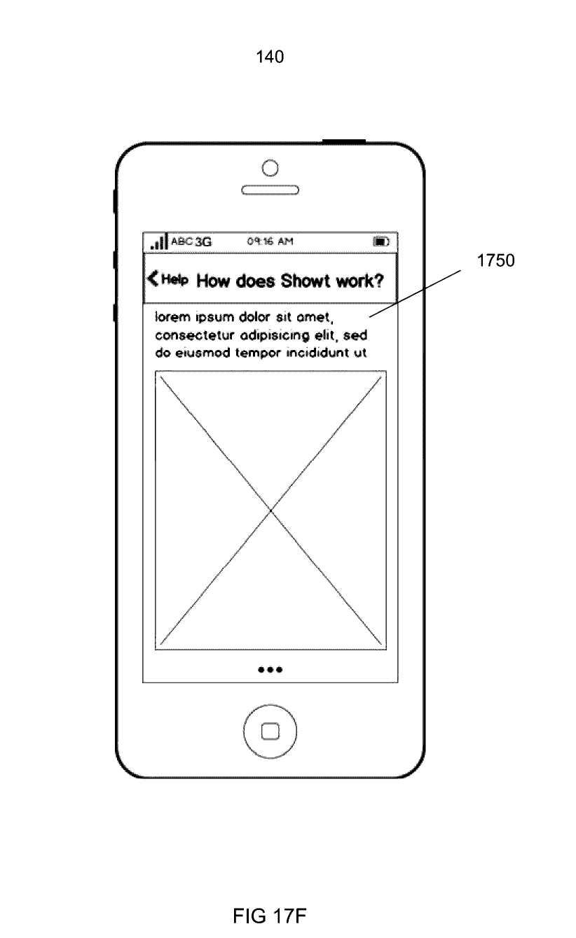

A feedback UI 1600 according to an embodiment of the invention is illustrated in FIG. 16, wherein a user may send a message to the platform that may be received at the server and delivered to an appropriate recipient such as a customer service representative. FIG. 17A illustrates one embodiment of a help UI 1700 that may include links to detailed UI sections such as about, frequently asked questions, privacy policy, terms of service, and the like. FIG. 17B illustrates one embodiment of an about UI 1710, which may provide details about the app and/or voting service. FIG. 17C illustrates one embodiment of a privacy policy UI 1720, which may display a privacy policy to which a registered user has agreed. FIG. 17D illustrates one embodiment of a FAQ UI 1730, which may display questions about the app and/or voting service and related answers. FIG. 17E illustrates one embodiment of a terms of service UI 1740, which may display terms of service to which a registered user has agreed. FIG. 17F illustrates one embodiment of a tutorial UI 1750 which may allow users to view tutorial information about the app, such as the tutorial information described above.

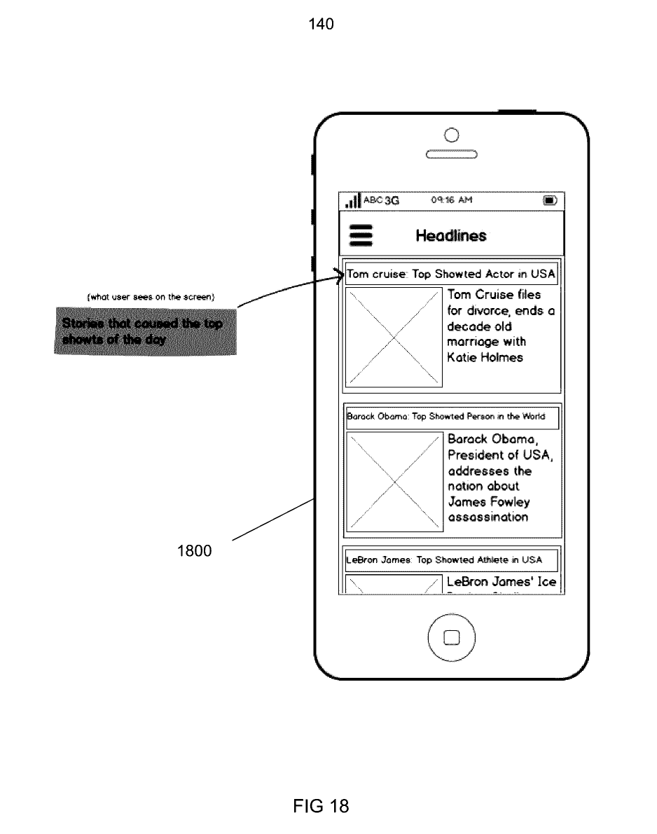

FIG. 18 illustrates one embodiment of a headlines menu UI 1800 that may include headlines and information corresponding to top voted targets. For example, the UI of FIG. 18 shows the actor and athlete in the USA and person in the world receiving the most votes in a given day. A user may be able to view top vote getters in other categories as well.

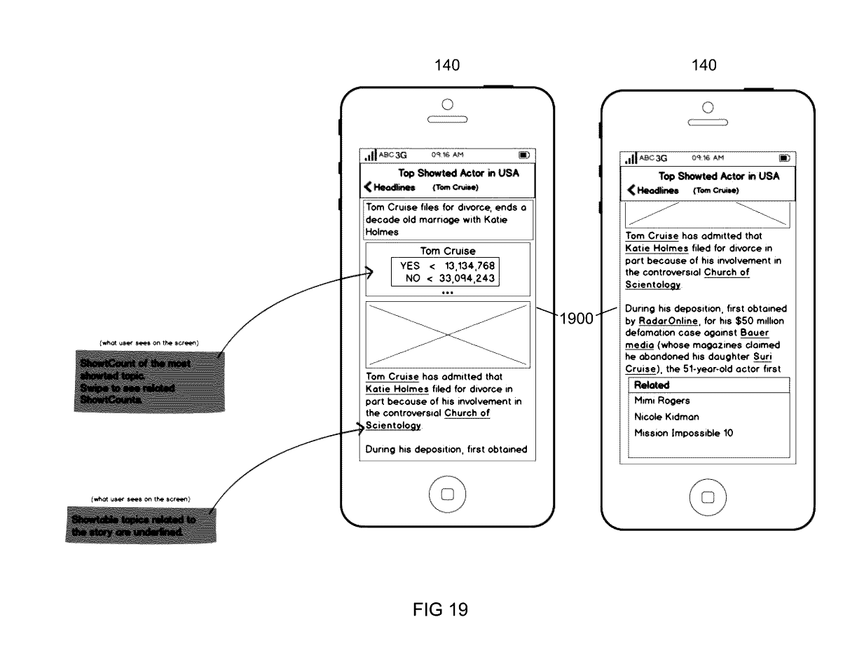

FIG. 19 illustrates one embodiment of a headline UI 1900 that may include detailed voting data and related topics of a headline topic. For example, a news headline may be displayed, and voting data and/or the option to vote on a subject of the headline may be provided. A news story about Tom Cruise may provide vote information about Tom Cruise and/or topics related to Tom Cruise (e.g., Scientology, Mimi Rogers, Nicole Kidman, Mission Impossible).

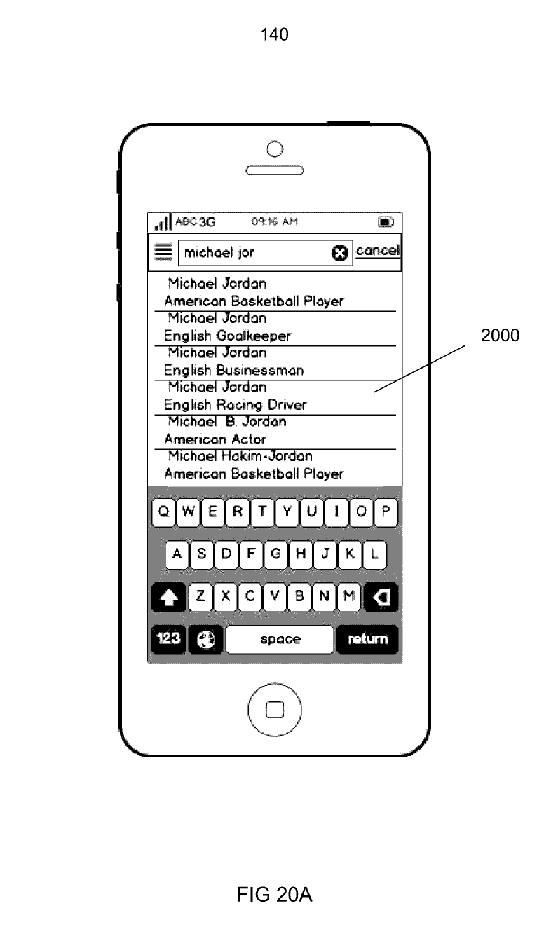

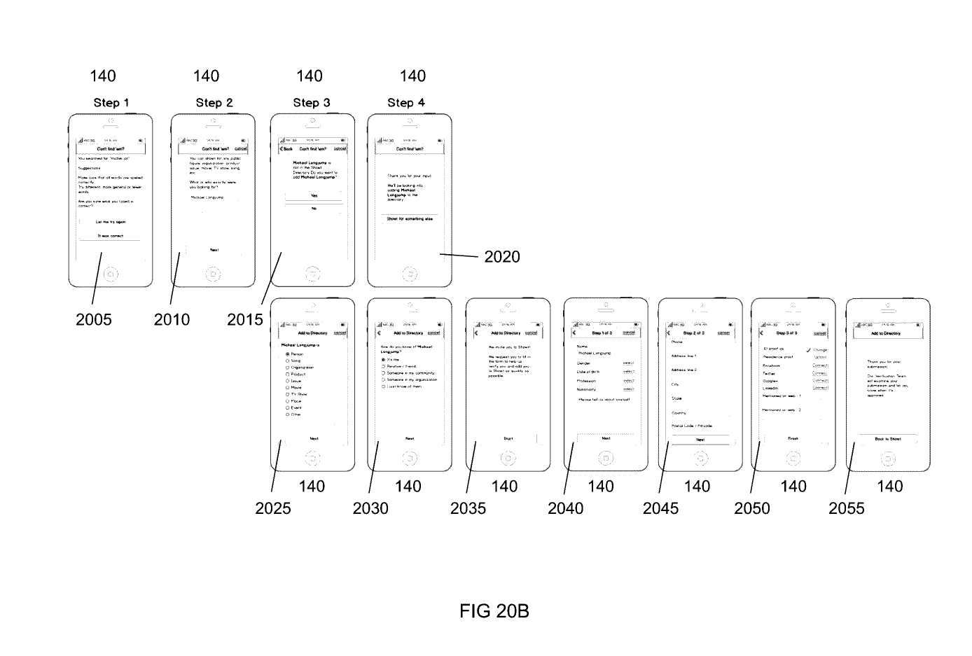

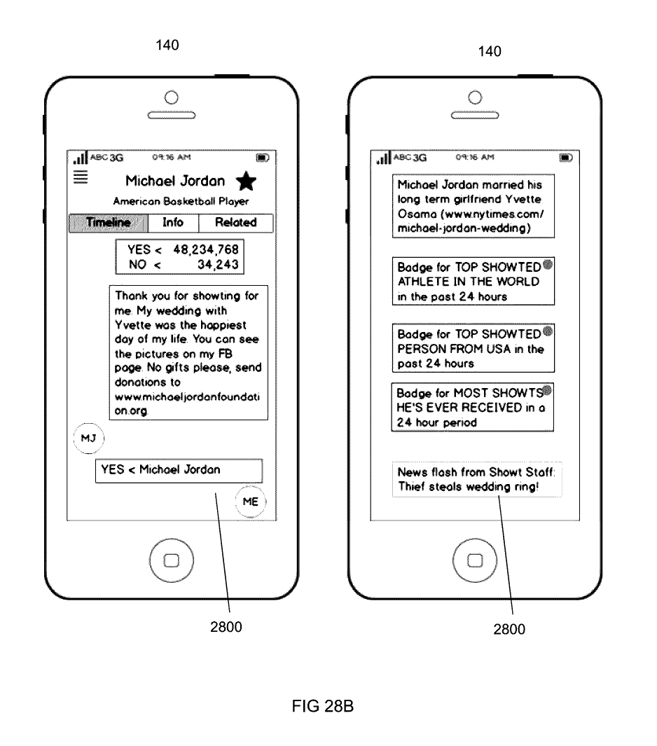

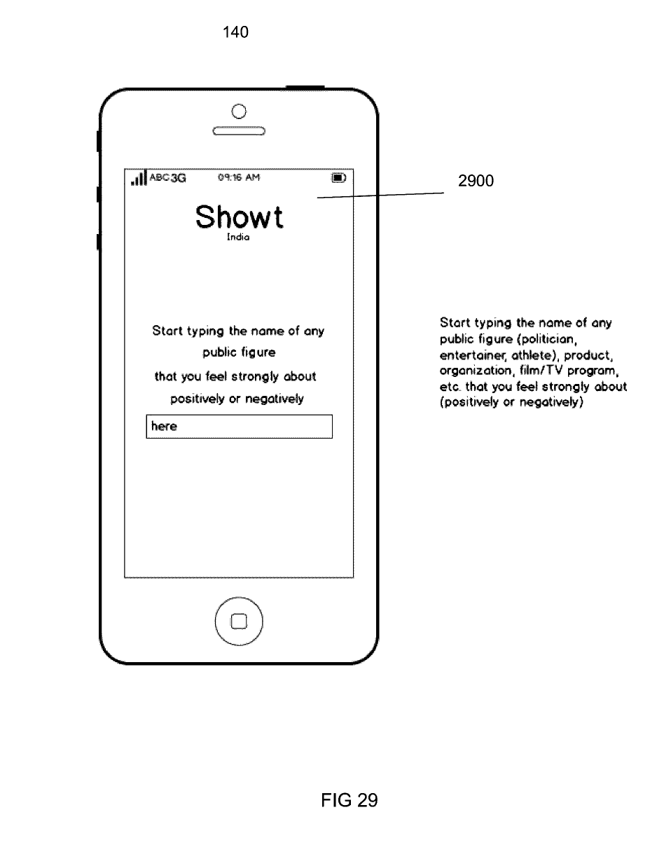

FIG. 29 illustrates one embodiment of a user input UI 2900 for a user to input the name of a target for voting. A user may be able to enter a topic and may be presented with results related to their inquiry, as shown in FIG. 20A, for example. One or more databases, such as those described above for example, may maintain polls on a variety of topics. For example, editors/administrators may be able to identify topics which may be of interest to members of the public or specific subsets thereof and create entries for these topics, which may then be available for voting. Also, as described below, users may be able to suggest topics for inclusion in the database, which may be evaluated by editors/administrators and potentially added to the database.

FIG. 20A illustrates one embodiment of a search results UI 2000 generated based on user input. The results may automatically populate with matches and/or near matches of a user's inquiry. For example, a user may begin typing “Michael Jordan” and topics related to Michael Jordan may be displayed. If the user sees the topic they were searching for, they may be able to select the topic and vote on it. For example, a near match may be a suggestion based on the input data in which the suggestion is similar to the data, a suggestion based on the input data in which the suggestion is a topic that may be of interest to the user based on the user entry, and/or a suggestion based on the input data in which the suggestion is a similar topic, person, or event to the user entry.

If a topic of the user's interest is not found in the search results, the user may be able to suggest the topic for future voting. This may allow users to have some control over the topics that may be voted on, because any topic could potentially be added upon user suggestion. FIG. 20B illustrates one embodiment of a topic request UI 2005-2055. If no results are returned (or if the user indicates that the topic of interest did not appear in the returned results), in 2005 the UI may ask the user to confirm the correct spelling of the search. If the spelling is wrong, the user may be able to retry the search with the correct spelling. If the spelling is right, in 2010 the user may enter the exact topic of interest. In 2015 the user may confirm that they would like to add the topic, and in 2020 the app may indicate that the topic is being investigated for inclusion into the database. The topic may be passed to a backend user (e.g., an admin or an editor) who may determine whether it is a topic that should be added (e.g., a public figure who is not yet in the voting database). In some embodiments, entering the topic of interest may include additional user input, as shown in 2025-2055. For example, the user may be able to specify what the topic is (e.g., person, organization, place, etc.) and how the user knows of the topic. The user may be required to provide information verifying the topic. For example, if the user knows about the topic because the user is the person (the topic) to be voted on, the user may be required to provide biographical information.

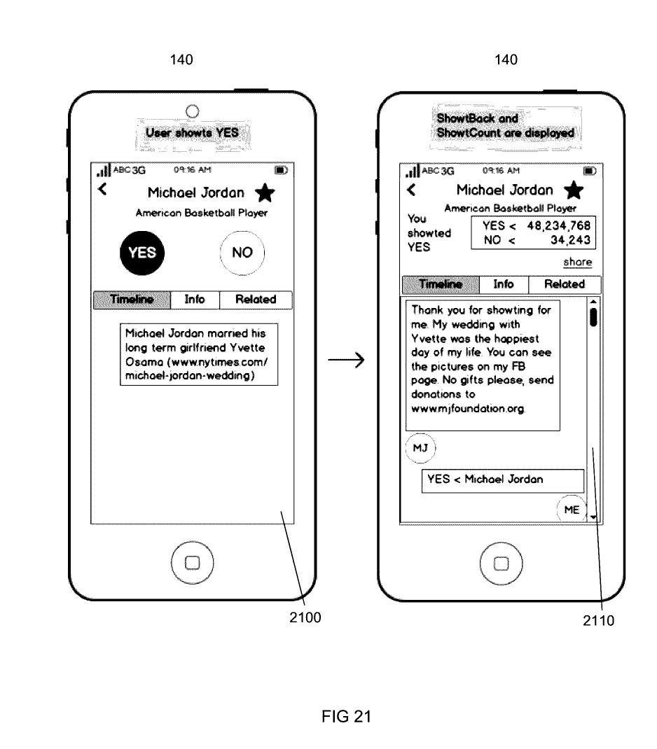

FIG. 21 illustrates one embodiment of a voting UI 2000 and voting results UI 2110. Target information including timeline information and related information may be presented with the options to vote in UI 2100. After voting, voting results UI 2110 may provide voting results/statistics. The voting statistics may include voting results from all users who have voted on a topic (including users who have voted from varying geographic locations and/or in various languages in some embodiments), or the statistics may include a subset of votes based on time (e.g., only votes cast within a certain time period, only votes cast after an event related to the topic, etc.), geographic location or language of voter, or other criteria. In some embodiments, the user may be able to filter voting statistics displayed based on some or all of the criteria. Additionally, the voting results may include a message from and/or related to the topic that may be correlated to the vote. For example, if a user votes “yes” to Michael Jordan after his marriage, the user may receive a message thanking the user for their best wishes on the wedding and providing more information (e.g., wedding photos and an opportunity to donate to a charity). A “no” vote may prompt the same message or a different message. For example, an approving vote of an executive order issued by Barack Obama may receive a note of thanks, while a disapproving vote may receive an acknowledgment of the user's concern and an explanation of why the executive order was issued. The messages may also include advertisements, wherein the advertisement may be selected based on the vote. For example, a person who votes “yes” on the Obama topic may be shown an advertisement for a Democratic fundraising campaign, while a person who votes “no” on the Obama topic may be shown an advertisement for a Republican fundraising campaign.

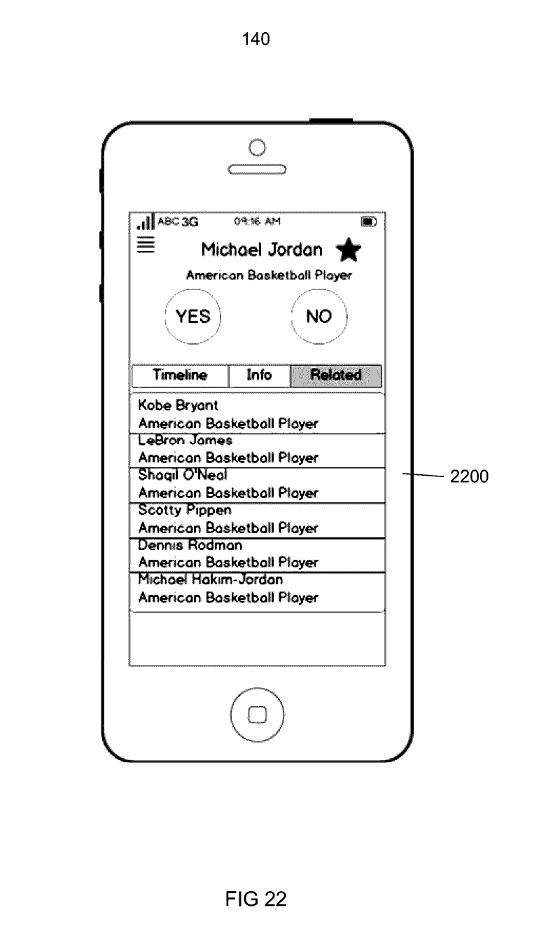

FIG. 22 illustrates one embodiment of a voting UI 2000 where related information is provided of targets related to the voting target. For example, a user voting on Michael Jordan may be shown other basketball players.

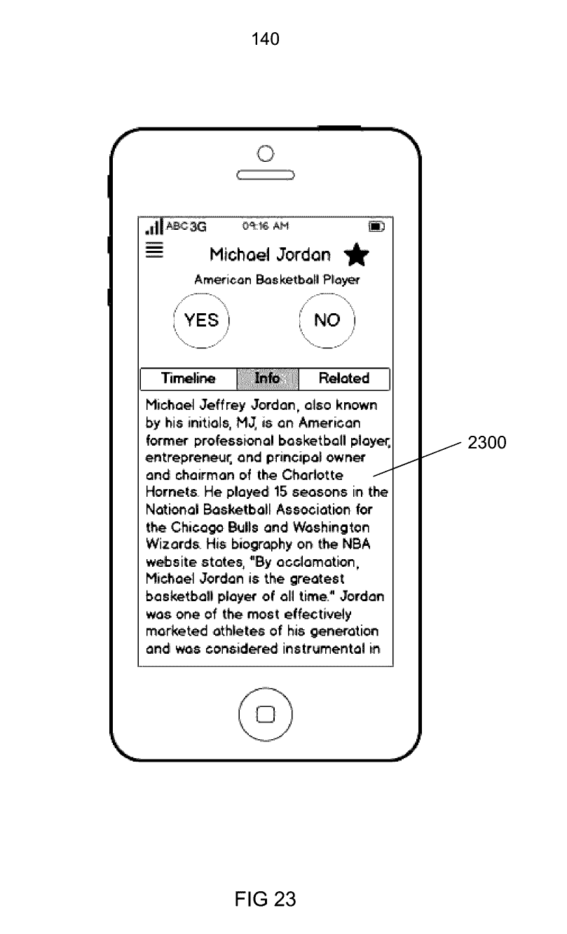

FIG. 23 illustrates one embodiment of a target UI 2300 where target information is provided. For example, biographical information about Michael Jordan is provided.

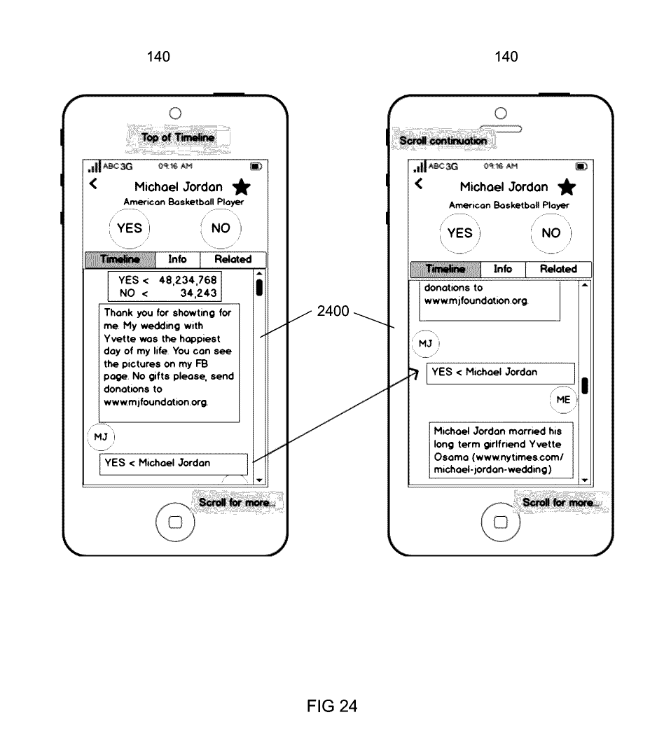

FIG. 24 illustrates one embodiment of a timeline UI 2400 showing how the UI changes as a user scrolls through a timeline. The timeline may show a user's past activity (e.g., votes, topical information, vote responses) related to the topic.

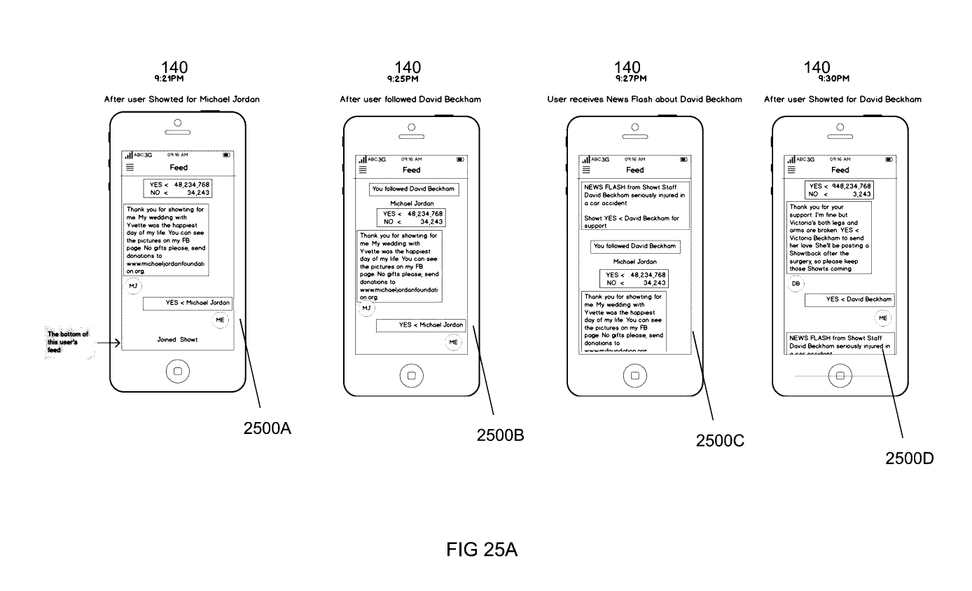

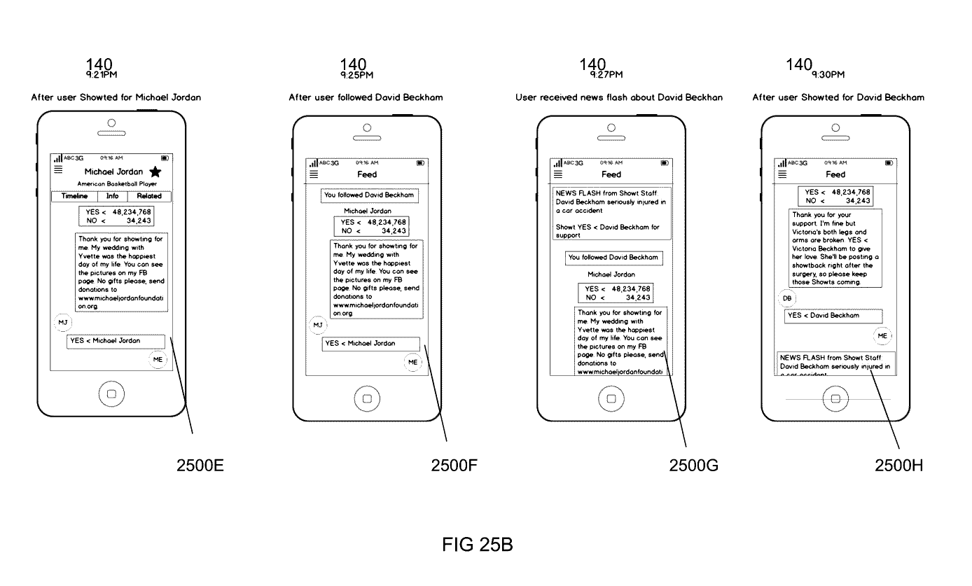

FIG. 25A-25B illustrates one embodiment of an activity feed UI 2500A-2500H. As the user performs actions such as voting, following topics, viewing topic updates, etc., the timeline may populate with records of these actions, which the user may subsequently view.

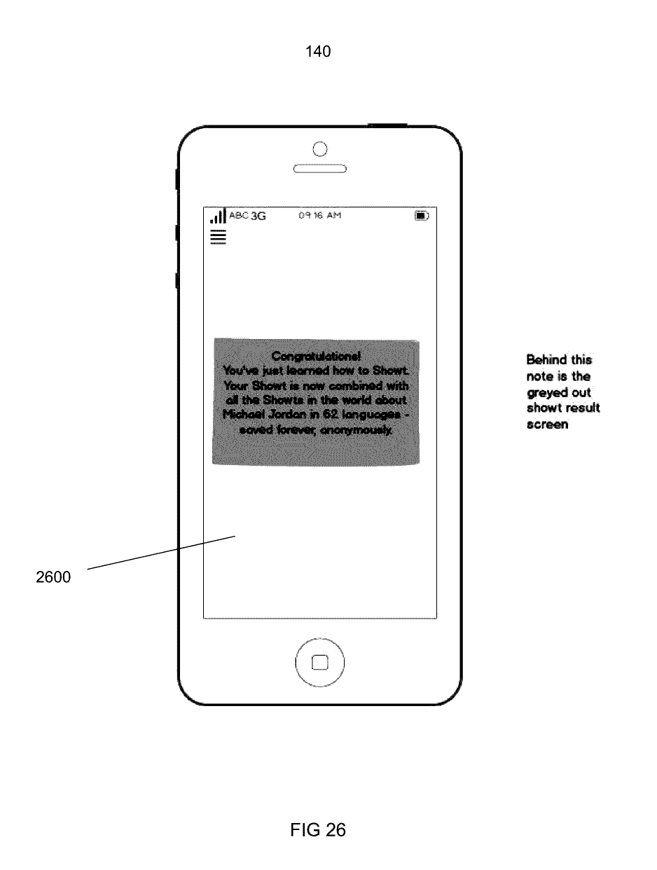

FIG. 26 illustrates one embodiment of a voting UI 2600. In some cases, after a user votes for a first time, a congratulatory message such as the one shown in FIG. 26 may be shown. For future votes, the message shown may be a basic confirmation of the vote or some other message, or no message may be shown.

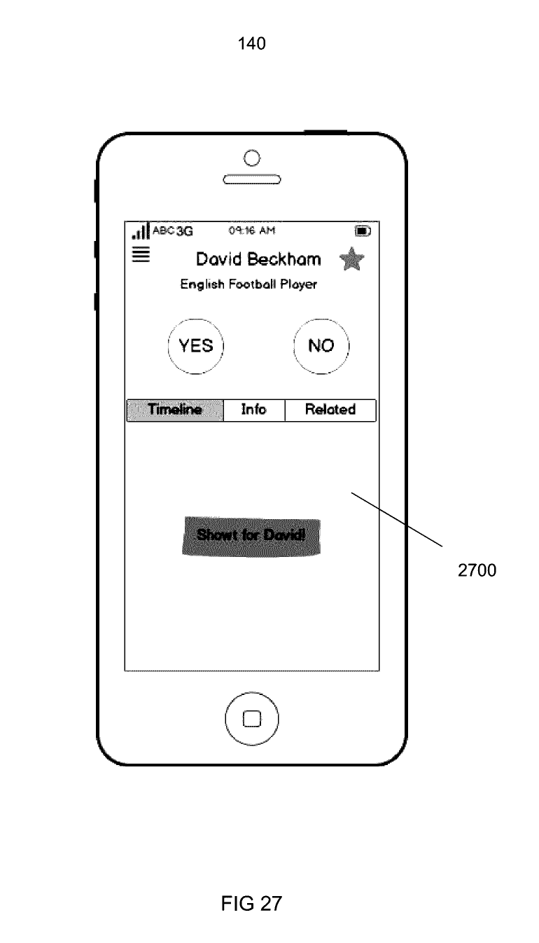

FIG. 27 illustrates one embodiment of a voting UI 2700. A user may follow a topic. For example, the user may have followed David Beckham. This is shown in FIG. 27 by a highlighted star next to David Beckham's name, although other embodiments may indicate a followed topic in other ways. A user may receive automatic updates about a followed topic in their timeline, for example.

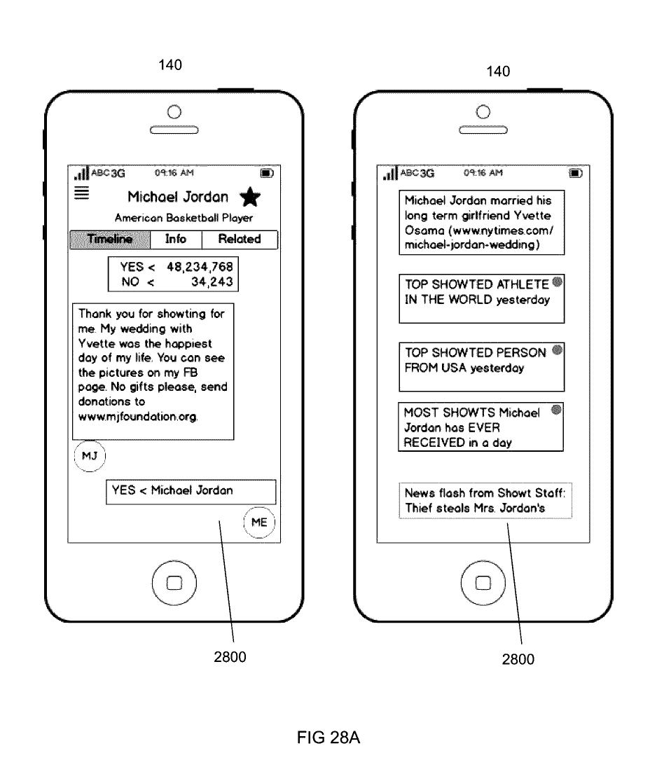

FIGS. 28A-28B illustrates one embodiment of a timeline feed UI 2800 updated in real-time. The timeline of FIG. 28A may be a timeline of a user other than the topic (i.e., not Michael Jordan), while the timeline of FIG. 28B may be a timeline of the user associated with the topic (i.e., Michael Jordan's own timeline). Events that are shown in the timeline of FIG. 28A may appear as badges earned in the topic user's timeline of FIG. 28B.

FIG. 30 is a UI launch process 3000 according to an embodiment of the invention. UI launch process 3000 may begin with a user status determination 3005 that determines the number of times the application has been used. The process 3000 may proceed to execute tutorial 3010 for a user's first use of the application. The tutorial 3010 may be a guided tutorial that includes the UI displays and functionality discussed above with respect to FIGS. 6A-6F. Upon completion of the tutorial 3010, the user may be displayed a home screen 3080 such as the UI 500 of FIG. 5 or the like.

If the user status 3005 determines that the application is launched for the second time, the process may proceed to request location 3015 that requests a user to input their location or grant access to location data generated by a GPS of a mobile phone. For instance, the UI 700 of FIG. 7A may display a message requesting access to a user location. The user input is received and is used to determine at step 3020 if location access is granted. If granted by the user, then the location of the user device may be detected at step 3025, and a corresponding location selection UI 3030 may be displayed as illustrated in FIG. 7B. If location access is not granted, then a location selection screen may be displayed, such as UI 720 of FIG. 7C, displaying a list of countries for a user to select from. The process may then determine if the user takes action 3035 to affirm the location selection or skip the selection altogether. A location selection 3040 may be received, followed by display of home screen 3080. If skipped, the home screen 3080 may be displayed.

When user status determination step 3005 determines that the application is being used for a third time, the user may be requested to sign-up/sign-in. The user may be presented a UI 800 such as illustrated in FIG. 8A where a user may skip 801 the sign-up/sign-in process, sign-up via credentials from another platform such as a social network, register with the platform itself or sign-in 802 to the platform. FIG. 8B illustrates an embodiment where a user is presented a sign in UI 810 where a user may sign-up 812 for service. If the user action 3050 in response to the sign-up request 3045 is to skip 3060 sign-up, the process may return to display the home screen 3080. If the user has previously signed up for the service and inputs a sign-in, the sign-in is received 3060. The user may alternatively register at step 3055.

After sign-in 3060 or registration 3055, a determination may be performed of whether a user's previous and current locations are the same. If so, at step 3065, the home screen 3080 may be displayed. If not, the application may request a location update 3070 such as a request for location from user profile 3075. For example, FIG. 8C shows a UI 820 where a user is requested to allow past activity to be associated with the newly created account, which may include location information. The user may choose their location or skip the request and default to using the last location. Regardless, the location selection is received at step 3040, and the home screen 3080 may be displayed thereafter. Next, upon a determination at step 3005 of a fourth use, the application may display the home screen 3080 or a display such as shown in the UI 900 of FIG. 9.

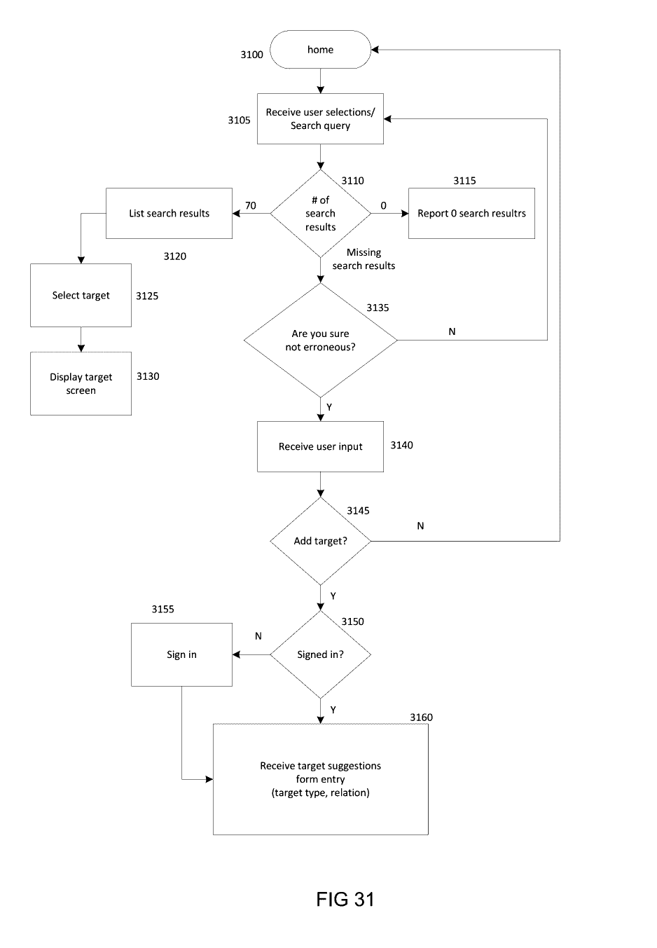

FIG. 31 is a search process 3100 according to an embodiment of the invention. The search process 3100 begins with a display of a home screen. For example, UI 2900 of FIG. 29 may be presented for a user to provide input. A user selection/search query 3105 is received and the number of search results 3110 is determined. If search results are available, then the search results may be listed 3120 for a user to select a target 3125. In one embodiment, the user may be presented a UI 2000 of FIG. 20A listing search results corresponding to user input of “michael jor”. Once a user selects a target, a target screen 3130 may be displayed, such as the UI 2100 of FIG. 21.

However, if zero search results are determined at step 3110, then a report of zero search results 3115 may be presented. If it is determined that there are missing search results at step 3110, then it may be determined at step 3135 whether the user input is erroneous. For instance, the UI 2005 of FIG. 20B may ask the user to confirm whether their input was correct. The process then returns to step 3105 of receiving user selection/search query or user input 3140 such as provided in UI 2010. A determination is performed whether to add target 3145 based on user input 3140. For example, a UI 2015 may be displayed to determine if a new target is to be added. If not, then the process may return to step 3105. However, if a user affirms to add a new target, then a determination is performed to determine if the user is signed in at step 3150. The user may be signed in at step 3155. Once signed in, target suggestions are received which may include target type, relational information, and the like. For example, target suggestions 3160 may include UIs 2025, 2030, 2035, 2040, 2045, 2050, 2055 of FIG. 20B.

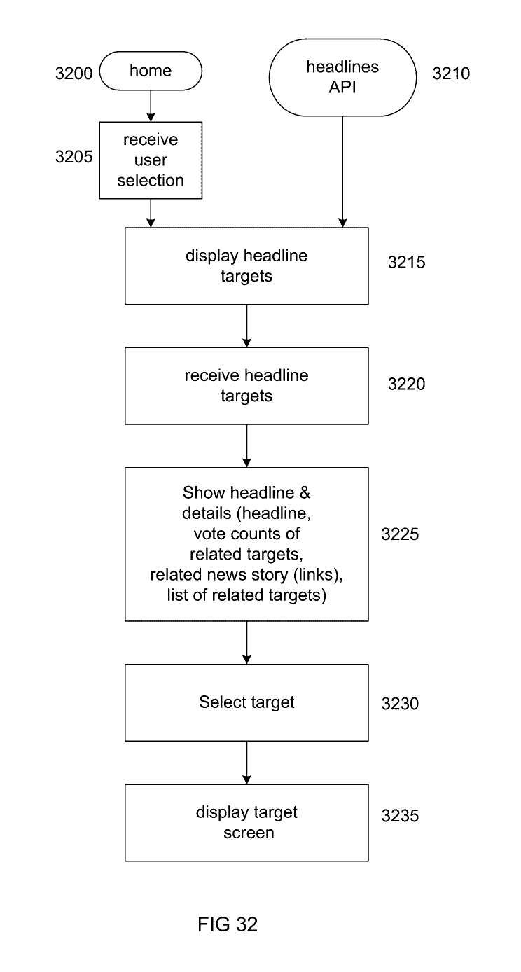

FIG. 32 is a headline display process 3200 according to an embodiment of the invention. A user selection 3205 is received and then a display of headline targets 3215 may be generated based on output from a headline API 3210. The UI 1800 of FIG. 18 illustrates a headline display. Headline targets 3220 may be received from user selection and then the headline and corresponding details 3225 may be expanded in a UI display. The details may include vote counts of related targets, related new stories, links, a list of related targets, and the like. A user selects a target 3230 and a target screen 3235 may subsequently be displayed.

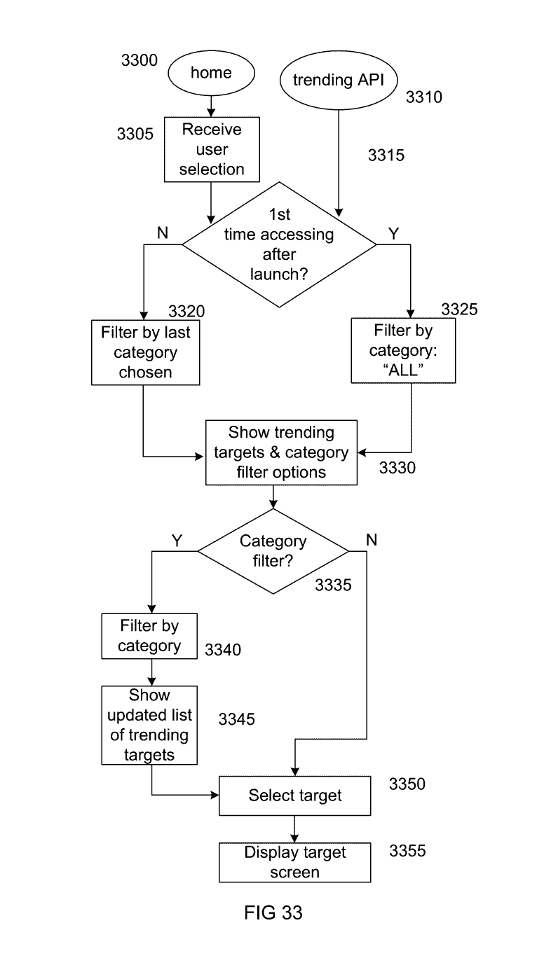

FIG. 33 is a trending topic display process 3300 according to an embodiment of the invention. A user selection 3305 is received and then a determination may be performed of whether the application is being accessed for the first time. If so, then a category filter 3325 is set to “ALL”. If not the first time, then the filter is set according to the last category 3320. Then, based on the filter settings and trending API 3310, a display of trending targets and category filter options 3330 are displayed. If a category filter 3335 is selected, such as that shown in UI 1300 of FIG. 13, then the trending targets are filtered by the selected category 3340 and an updated list of trending targets 3345 may be displayed. A target selection 3350 may be performed and the trending API 3310 may then generate and display a corresponding target screen 3355. FIG. 14 illustrates a UI 1400 of trending targets with an option to filter 1410 the results.

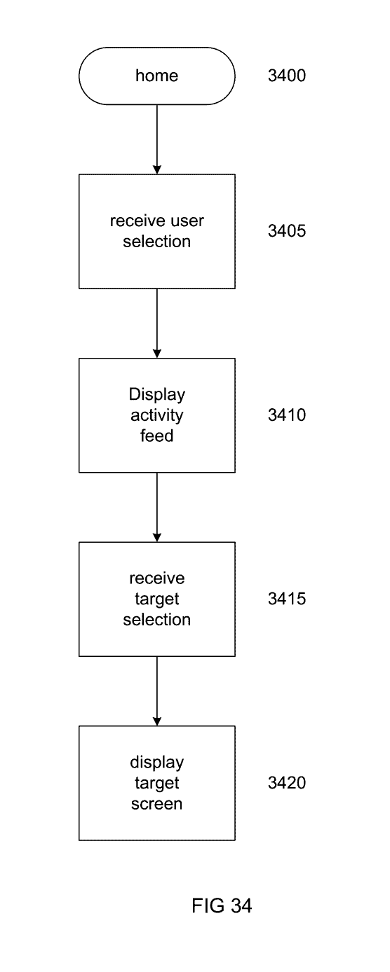

FIG. 34 is an activity display process 3400 according to an embodiment of the invention. A user selection 3405 is received and may be processed in order to display an activity feed 3410. A target selection is received 3415 and may be processed to display a corresponding target screen 3420.

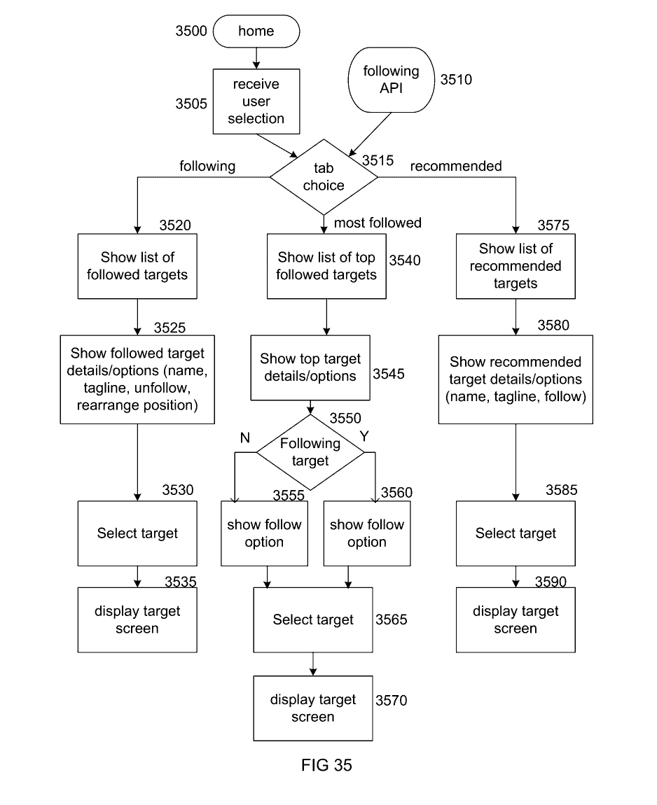

FIG. 35 is a followed topic display process 3500 according to an embodiment of the invention. A user selection is received at step 3505 corresponding to the tab choices of following, most followed and recommended. The selected tab choice is determined at step 3515. For a selection of following, a list of followed targets 3520 is displayed. FIG. 10 illustrates one embodiment of a following UI 1000. The UI may also display a followed target details/options 3525 including name, tagline, unfollow, or allow the target to rearrange position. A target may be selected 3530 and a corresponding target screen displayed 3535.

For the selected tab choice of most followed, a list of top followed targets 3540 may be displayed. FIG. 11 illustrates one embodiment of a most followed UI 1100. The UI may also display a most followed target details/options 3545. A determination is performed at step 3545 of whether a target is being followed. If not, a follow option 3555 may be displayed. If so, a follow option 3560 may be displayed. A target may be selected 3565 and a corresponding target screen displayed 3570.

For the selected tab choice of recommended, a list of recommended targets 3575 are displayed. FIG. 12 illustrates one embodiment of a recommended UI 1200. The UI may also display a recommended target details/options 3525 including name, tagline, follow option. A target may be selected 3585 and a corresponding target screen displayed 3590.

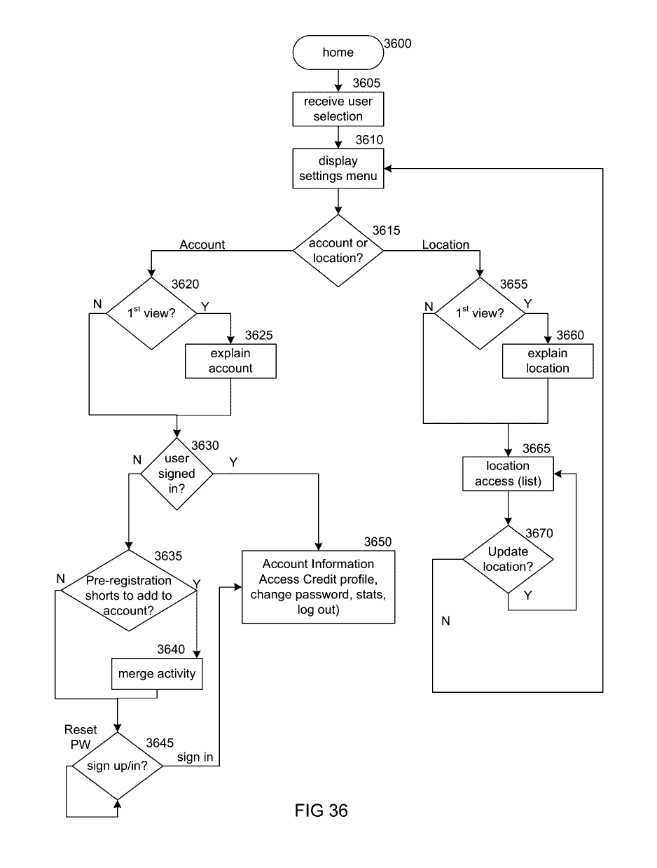

FIG. 36 is a settings adjustment process 3600 according to an embodiment of the invention. A user selection 3605 may be received to adjust settings. A setting menu display 3610 may be presented such as the UI 1500 illustrated in FIG. 15A. A user makes a selection from the setting menu, and a determination 3615 is performed of whether an account or location is selected. For a selection of location from the settings menu, a determination 3655 is performed of whether the location setting menu is being viewed for the first time. If so, the location setting process 3660 is explained. Then, a location access list 3665 is displayed. FIG. 15B illustrates one embodiment of a location access list UI 1510. The user may then update a location 3670 as illustrated in UI 1510 of FIG. 15C. After a location is updated, the UI may return to the display settings menu 1500.

For a selection of account from the settings menu, a determination 3620 is performed of whether the account setting menu is being viewed for the first time. If so, the account setting process 3625 is explained. Then, a determination 3630 is performed of whether a user is signed in. If a user is signed in, then the user may be provided access to account information such as credit profile, password, statistics, log out, etc. for review and modification. For example, FIG. 15G illustrates one embodiment of a password reset UI 1540. FIG. 15H-15I illustrate embodiments of an account settings UI 1550 and UI 1560. If a user is not signed in as determined in step 3630, then the user may be presented a sign-up display 3635. The user may be presented an option to merge past activity 3640 with the sign-in account. FIG. 15E illustrates one embodiment where a sign-up UI 1520 is displayed with the option to merge past activity. A determination may then be performed at step 3645 of whether a user has signed in or signed up. A password reset process may be performed if necessary, as illustrated in UI 1540 of FIG. 15G. Once the user is signed in, access to account setting information is granted. After account settings are reviewed and/or updated, the UI may return to the display settings menu 1500.

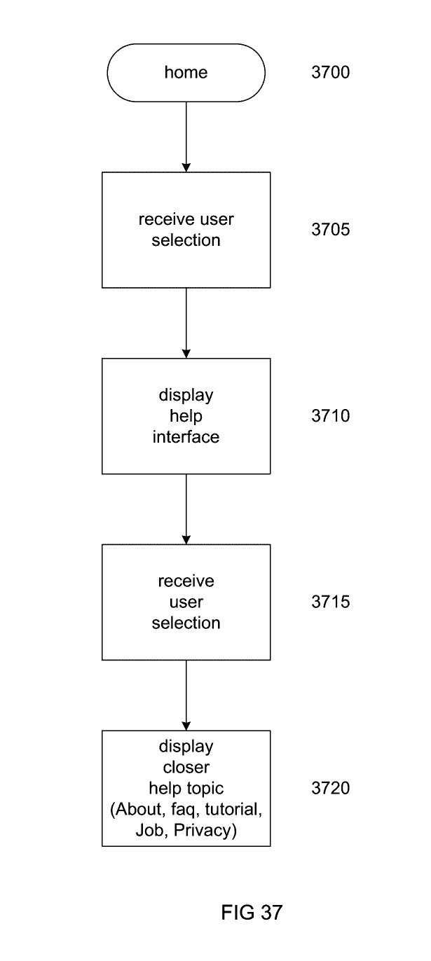

FIG. 37 is a help display process 3700 according to an embodiment of the invention. A user selection 3705 corresponding to a request for help is received and may be processed in order to display a help interface 3710. FIG. 17A illustrates one embodiment of a help UI 1700. A user selection is received 3715 and may be processed to display a corresponding closer help topic 3720 such as an About UI 1710, FAQ UI 1730, tutorial UI 1750, Job UI, privacy UI 1720, terms of service UI 1740, etc., as illustrated in FIGS. 17B-17F.

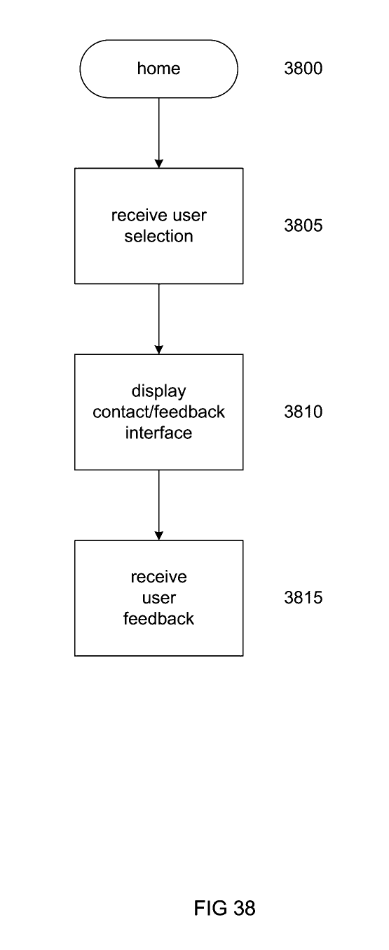

FIG. 38 is a feedback entry process 3800 according to an embodiment of the invention. A user selection 3805 is received and may be processed in order to display a contact/feedback interface 3810. User feedback 3815 may then be received. In one embodiment, a feedback UI 1600 is illustrated in FIG. 16.

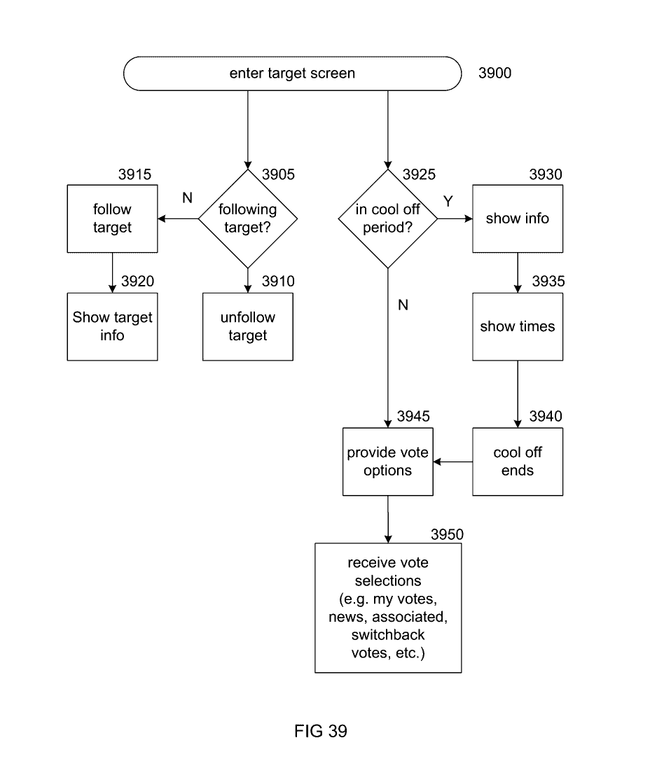

FIG. 39 is a vote entry process 3900 according to an embodiment of the invention. A target is selected and a determination 3905 is performed of whether the user is following the selected target. If so, the option to unfollow target 3910 may be presented corresponding to the target. Otherwise, an option to follow the target 3915 may be presented and target information 3920 may be displayed if the target is followed.

In the vote entry process, a cool off period 3925 is determined as active or ended. The cool off period ensures that a user does not vote in quick succession, thus skewing the aggregated data. During an active cool off period, information 3930 related to the target and cool off period 3935 may be displayed. Once the cool off period ends at step 3940, the process then may proceed to voting step 3945. If there is no active cool off period, then the user is provided vote options 3945. In one embodiment, FIG. 21 shows a UI 2100 where a user is presented vote options. The selected vote 3950 is received and related voting information may be displayed, as illustrated in UI 2110.

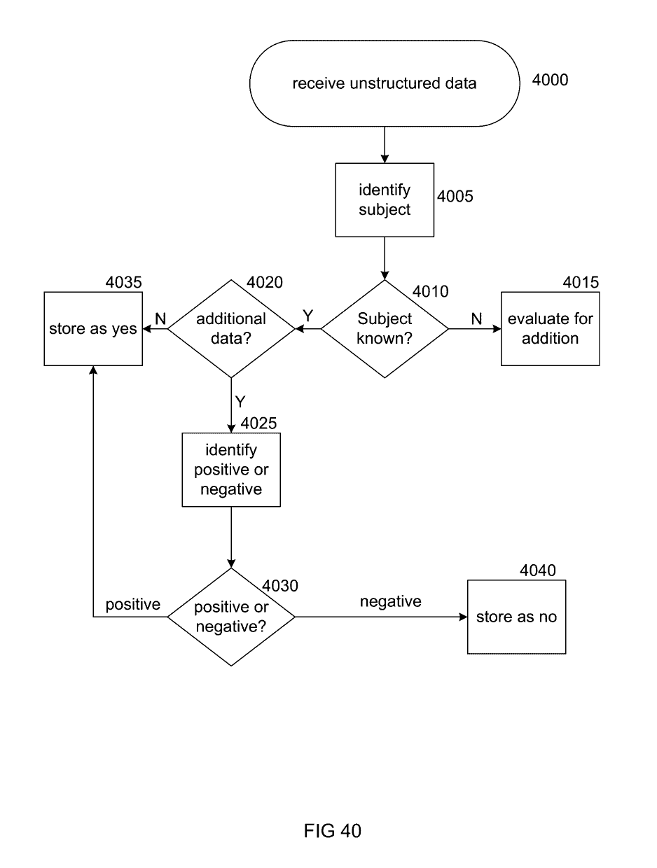

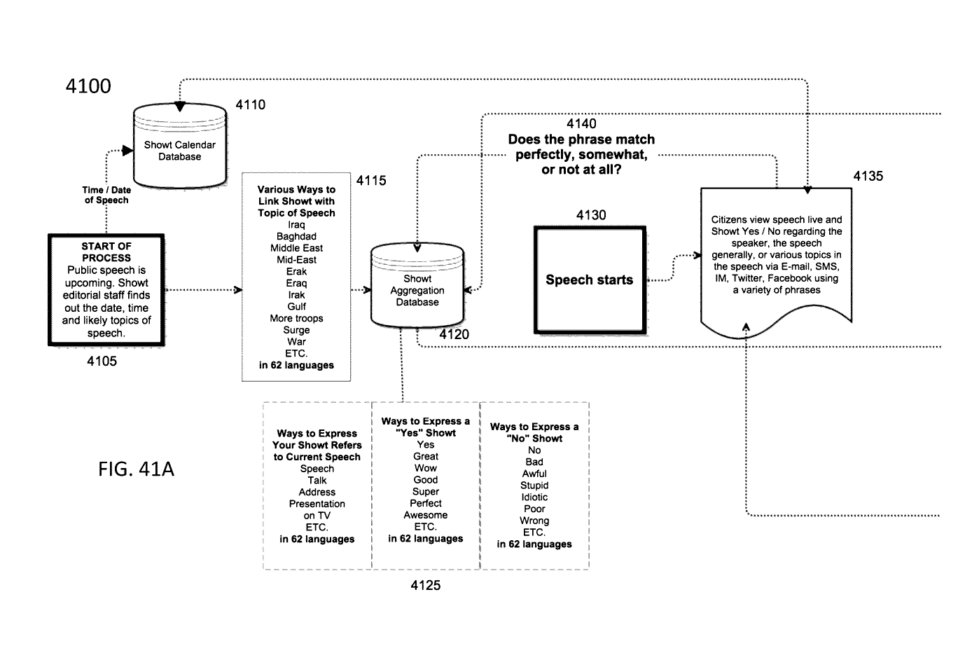

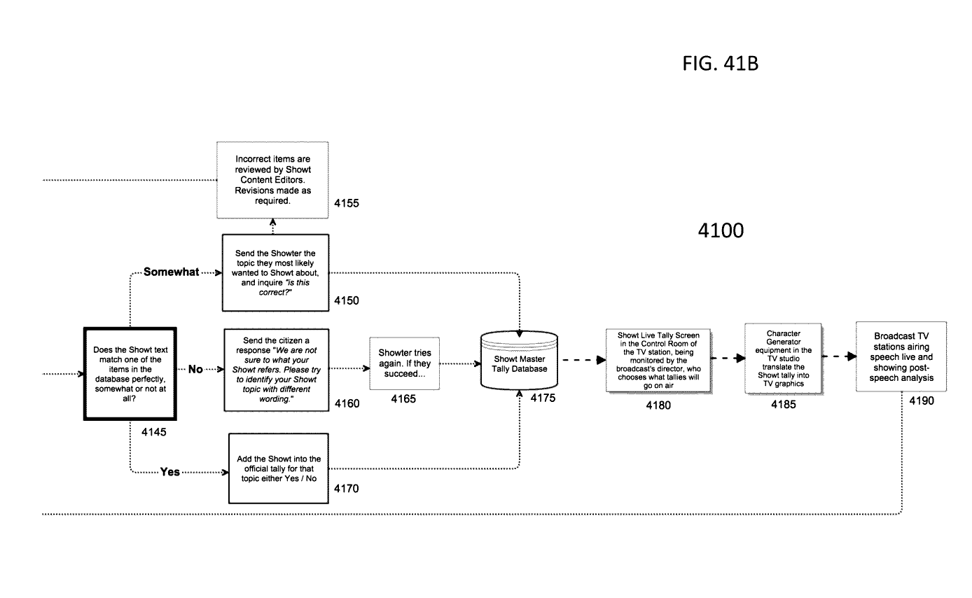

FIG. 40 is a free-form voting process 4000 according to an embodiment of the invention. In addition to, or instead of, the UI-based voting wherein the voter may be able to see if their entry matches the existing database, for voting shown above, the system (e.g., one or more of the vote server 110, parser server 120, and/or web server 130) may be able to receive votes in an unstructured/free-form manner from one or more sources, interpret the meanings of the unstructured/free-form votes, and add votes to the tally of the subject to which they relate. Unstructured/free-form data may be received 4000 from any of a variety of sources (e.g., email, SMS/MMS, Twitter, etc.), wherein a user sends a message in a free-form manner to the system. The message may be analyzed, and a subject may be identified 4005. For example, a user may send a tweet to the system that says “Michael Jordan stinks.” If the subject is unknown 4010, it may be stored for further evaluation 4015 in some embodiments, or disregarded. If the subject is known (e.g., “Michael Jordan” is identified as the subject), the system may identify any additional data in the message 4020 (e.g., “stinks”). If there is no additional data (e.g., the message simply says “Michael Jordan”), the message may be counted as a NO vote 4035 (in some embodiments, the message may be counted as a YES vote by default instead). If there is additional data, it may be evaluated 4025 to determine whether it is positive or negative 4030. If it is positive (e.g., Michael Jordan “rules”), a yes vote may be counted 4035. If it is negative (“stinks”), a no vote may be counted 4040. This is described in greater detail in FIG. 41 below. FIGS. 41A-41B show a free-form voting process that may not allow the voter to view whether the target they are entering for voting matches an existing database entry 4100 within a UI according to an embodiment of the invention. In this example, the voting process 4100 is based on an event (e.g., a speech on the war in Iraq), although the same process may be applied to other topics (e.g., a famous person, place, or thing generally). When a topic is identified 4105, a date associated with the topic may be stored if applicable 4110, and one or more editors may identify likely key words associated with the topic 4115. The key words may be translated into various languages and stored 4120, which may allow voting in a free-form fashion such that the voter may not be sure if the item they are voting on is included in the topic database, in any language supported by the system, just as voting in a UI where the voter may choose from a list of topics in the database may be supported in various languages as described above. Common and/or expected misspellings of the key words may also be stored. In addition to the curated key words, various ways to refer to the event (if applicable), ways to express yes, and ways to express no may be stored 4125. When the event begins 4130, users may send free-form vote entries 4135 (or, on general topics, users may send free-form items votes 4135 at any time). Data received from a user may be parsed to see if the words in the message match stored words or phrases 4140. If the data matches somewhat 4145 (e.g., a topic is misspelled in an unexpected way or a word is close to more than one word in the database), a reply may be sent to the sender 4150. The reply may ask the user for clarification and/or may suggest a topic that the system believes the user was interested in voting on. If the user confirms that the suggestion is correct, the vote may be tallied and stored appropriately 4175. If the suggestion is incorrect, the suggestion and/or user submission may be sent to an editor for review 4155. Adjustments to the stored key words may be made if appropriate. If the text from the user does not match anything in the database, a response may be sent indicating that the system is unsure of the topic and/or vote 4160. The user may try again 4165, and if the new submission matches a key word, the vote may be tallied and stored appropriately 4175. If there is no match, the system may again ask for clarification until a clear vote (or a somewhat matching vote) is received. If the text from the user is a direct match to one or more key words in the database, the vote may be added to the tally 4170 and stored 4175. The vote data may be displayed 4180. For example, vote information may be displayed on the broadcast of the speech and/or shown to users of the app, as described above. In some embodiments, the vote data may be displayed 4180 on a display in a control room of the broadcast so that it may be monitored, and choices may be made by the director of the news broadcast in the control room about which data may be displayed in the broadcast. In some embodiments, a character generator may translate the vote data into TV graphics 4185. The graphics and/or other data (e.g., data selected by a Director of the news broadcast for insertion into an on-air image) may be broadcast 4190.

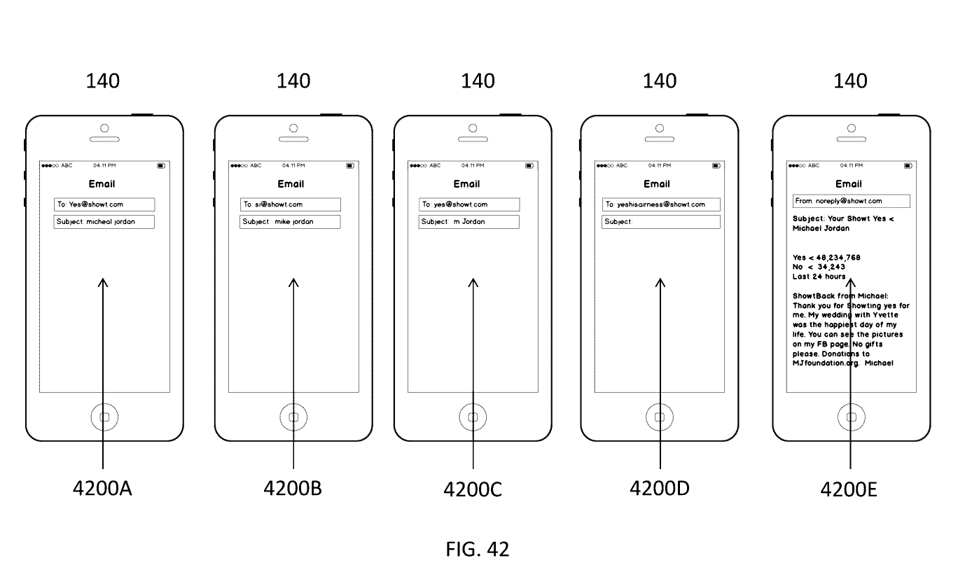

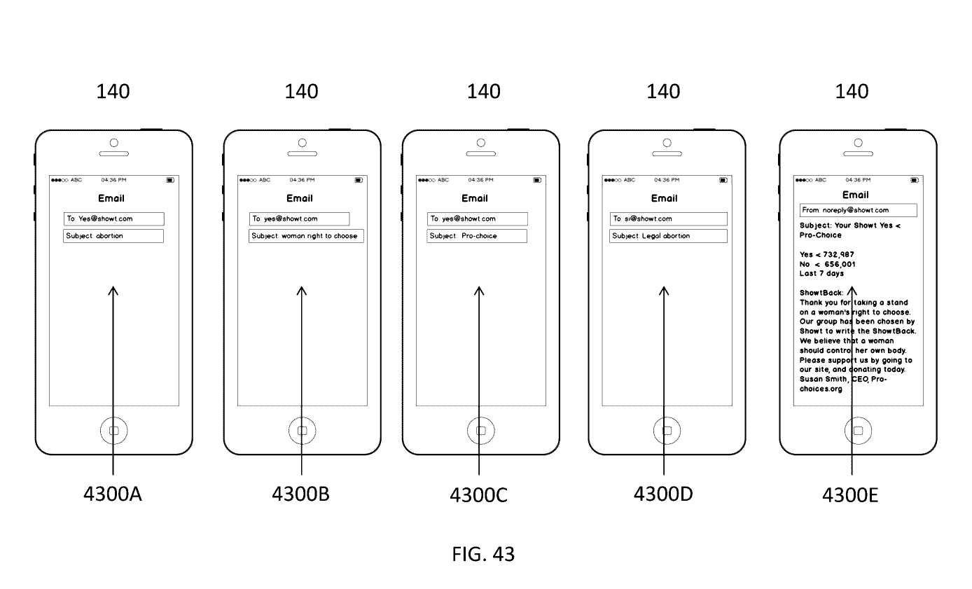

FIGS. 42-43 are screenshots of a free-form voting UI that allows the user to vote without knowing whether the target they are entering for voting matches an existing database entry according to an embodiment of the invention. In these examples, the UI of the device 140 is an email UI for an email app or web-based email service, although it will be clear to one of ordinary skill in the art that similar votes may be cast using other services (e.g., text, web forms, or other systems described above). In FIG. 42, screenshots 4200A-4200D illustrate various examples of YES votes for Michael Jordan. As described above with respect to FIG. 41, the received votes may be compared to information in a database to identify a subject and vote. 4200A-4200C are examples wherein a user sends a message to an address associated with a YES vote (e.g., yes@showt.com or si@showt.com). The subject of each message is one of several possible ways to identify Michael Jordan. The system may match the subject to Michael Jordan based on the data in the database and record the YES vote for Michael Jordan. In 4200D, the email address includes data identifying both the vote (yes) and the subject (hisairness, wherein “His Airness” is a known nickname for Michael Jordan in the database). Likewise, in some embodiments, the email address could identify the topic while the subject identifies the vote, or an email could be sent to a general address with a subject line identifying both the topic and vote. In some embodiments, vote and/or subject information may be included in the body of the email. 4200E shows a possible response to any of the YES votes for Michael Jordan shown in 4200A-4200D. An email (or text or other message, depending on the service being used) may be sent to the address of the user who sent the vote. As with the UI-selection based voting discussed above, the message may include voting statistics and/or a customized message based on the vote and topic. FIG. 43 provides a similar example, wherein 4300A-4300D are four different ways to vote YES on the subject “pro-choice” using an email UI of a device 140, and 4300E is a response based on the received and parsed vote that may be sent to the voters of 4300A-4300D.

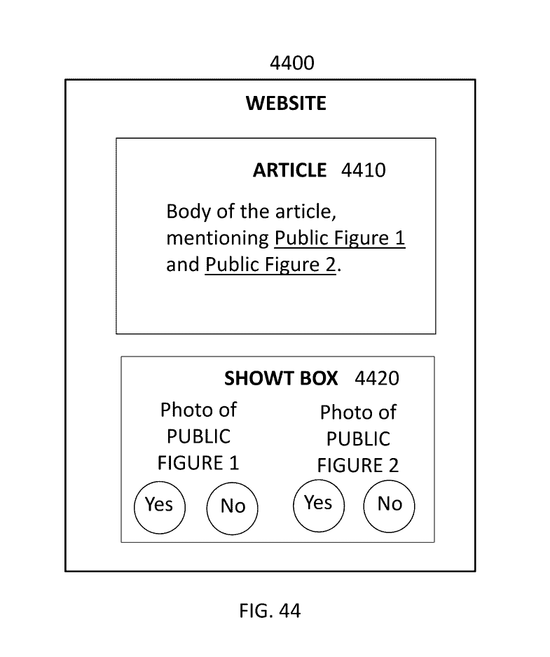

FIG. 44 is a screenshot of a website 4400 with embedded news widget according to an embodiment of the invention. A news widget may be integrated into any webpage 4400 or other network-based UI. For example, a website developer may download the news widget from a distributor. The news widget may be customized before it is inserted into a webpage 4400. For example, the way in which a topic is highlighted in the webpage 4400 text may be customizable. Options may include having the topic's name underlined, colored differently from the body text in the article, and/or having the topic name (and/or photo) featured in a box adjacent to the article. More than one option may be selected. The webpage 4400 of FIG. 44 shows examples wherein an article 4410 includes underlined topics (Public FIG. 1 and Public FIG. 2) and a box 4420 is provided in addition to the article 4410. Once inserted into the website's code, the news widget may automatically scan the text of the webpage 4400 and search for a match between the text and the topics in the database. When a match is found, the formatting protocol for topics may be followed automatically (e.g., through inserting links and/or boxes) to alert the reader of the opportunity for voting on the topic. The reader may then vote on the topic (e.g., provide a yes/no vote through a UI presented in the box or upon clicking the link), and processing may be performed as described in detail above. Analyzing the webpage 4400 and inserting the voting UI into the website's code may be performed by one or more of the servers described above or by a local processor at the website developer's computer, for example. The described features may be implemented advantageously in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures that highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A voting system comprising:
a server comprising a processor and a memory, the processor being configured to:
receive voting data;
analyze the voting data to identify a topic from among a plurality of topics and a vote associated with the identified topic; and
tally the vote for the identified topic.

2. The voting system of claim 1, wherein the processor is further configured to report a total tally for the identified topic.

3. The voting system of claim 1, wherein the voting data is received as an email, a tweet, an SMS message, an MMS message, a USSD message, a smart TV app generated message, a browser extension generated message, a website widget generated message, a message generated on a webpage, or an instant message.

4. The voting system of claim 1, wherein the voting data is received as part of a communication between a device and the server.

5. The voting system of claim 1, wherein the voting data is received via a network from a user device.

6. The voting system of claim 1, wherein analyzing the voting data includes identifying a match or a near match between at least one word in the voting data and at least one word.

7. The voting system of claim 1, wherein analyzing the voting data comprises identifying a near match between at least one word in the voting data and at least one word, requesting a confirmation that the near match is a match, and receiving the confirmation.

8. The voting system of claim 1, wherein analyzing the voting data comprises identifying a nearest match between at least one word in the voting data and one of a plurality of words, requesting a confirmation that the near match is a match, and receiving the confirmation.

9. The voting system of claim 1, wherein analyzing the voting data comprises parsing the voting data to identify a first portion of the voting data containing the topic and a second portion of the voting data containing the vote.

10. The voting system of claim 1, wherein:
the vote is a yes or a no;
the vote is one of two choices; or
the vote is one of a limited number of choices.

11. The voting system of claim 1, wherein:
the voting data includes free-form data entered by a user; and
analyzing the voting data comprises identifying at least one word in the free-form data.

12. The voting system of claim 1, wherein the voting data comprises text data.

13. The voting system of claim 1, wherein the processor is further configured to:
receive voting data comprising non-free-form data indicating a topic from among the plurality of topics and a vote associated with the topic; and
tally the vote from the non-free-form data.

14. The voting system of claim 13, wherein the non-free-form voting data is received via a network from a user device.

15. The voting system of claim 14, further comprising the user device, wherein the user device comprises a voting app configured to generate the non-free-form voting data.

16. The voting system of claim 1, wherein the processor is further configured to send a message in response to receiving the voting data.

17. The voting system of claim 16, wherein the message is selected based on the identified topic and vote.

18. The voting system of claim 1, wherein the processor is further configured to receive a user suggestion of a topic.

19. The voting system of claim 1, wherein the processor is further configured to transmit information about at least one of the plurality of topics.

20. The voting system of claim 1, wherein the voting data is received in a first language and tallied with at least one vote associated with the topic in at least one other language.

21. The voting system of claim 1, wherein the voting data is unprompted by a query.

22. The voting system of claim 1, further comprising a database containing the plurality of topics and a plurality of votes, wherein the analyzing comprises accessing the database to identify the topic, or the vote, or a combination thereof

23. The voting system of claim 1, further comprising a widget processor configured to analyze a webpage to identify at least one of the plurality of topics within the webpage and insert a voting interface into the webpage, wherein the voting data is received via the voting interface.

24. A voting method comprising:
receiving, with a processor of a server comprising the processor and a memory, voting data;
analyzing, with the processor, the voting data to identify a topic from among a plurality of topics and a vote associated with the identified topic; and
tallying, with the processor, the vote for the identified topic.

25. The voting method of claim 24, further comprising reporting, with the processor, a total tally for the identified topic.

26. The voting method of claim 24, wherein the voting data is received as an email, a tweet, an SMS message, an MMS message, a USSD message, a smart TV app generated message, a browser extension generated message, a website widget generated message, a message generated on a webpage, or an instant message.

27. The voting method of claim 24, wherein the voting data is received as part of a communication between a device and the server.

28. The voting method of claim 24, wherein the voting data is received via a network from a user device.

29. The voting method of claim 24, wherein analyzing the voting data comprises identifying a match or a near match between at least one word in the voting data and at least one word.

30. The voting method of claim 24, wherein analyzing the voting data comprises identifying a near match between at least one word in the voting data and at least one word, requesting a confirmation that the near match is a match, and receiving the confirmation.

31. The voting method of claim 24, wherein analyzing the voting data comprises identifying a nearest match between at least one word in the voting data and one of a plurality of words, requesting a confirmation that the near match is a match, and receiving the confirmation.

32. The voting method of claim 24, wherein analyzing the voting data comprises parsing the voting data to identify a first portion of the voting data containing the topic and a second portion of the voting data containing the vote.

33. The voting method of claim 24, wherein:
the vote is a yes or a no;
the vote is one of two choices; or
the vote is one of a limited number of choices.

34. The voting method of claim 24, wherein:
the voting data includes free-form data entered by a user; and
analyzing the voting data comprises identifying at least one word in the free-form data.

35. The voting method of claim 24, wherein the voting data comprises text data.

36. The voting method of claim 24, further comprising:
receiving, with the processor, non-free-form data indicating a topic from among the plurality of topics and a vote associated with the topic; and
tallying, with the processor, the vote from the non-free-form data.

37. The voting method of claim 36, wherein the non-free-form voting data is received via a network from a user device.

38. The voting method of claim 37, further comprising generating, with a voting app of the user device, the non-free-form voting data.

39. The voting method of claim 24, further comprising sending, with the processor, a message in response to receiving the voting data.

40. The voting method of claim 39, wherein the message is selected based on the identified topic and vote.

41. The voting method of claim 24, further comprising receiving, with the processor, a user suggestion of a topic.

42. The voting method of claim 24, further comprising transmitting, with the processor, information about at least one of the plurality of topics.

43. The voting method of claim 24, wherein the voting data is received in a first language and tallied with at least one vote associated with the topic in at least one other language.

44. The voting method of claim 24, wherein the voting data is unprompted by a query.

45. The voting method of claim 24, wherein the analyzing comprises accessing a database containing the plurality of topics and a plurality of votes to identify the topic, or the vote, or a combination thereof

46. The voting method of claim 24, further comprising analyzing, via a widget processor, a webpage to identify at least one of the plurality of topics within the webpage and inserting, via the widget processor, a voting interface into the webpage, wherein the voting data is received via the voting interface.
